(19) United States
(12) Patent Application Publication
(10) Pub. No.: US 2015/0278693 A1
(43) Pub. Date: Oct. 1, 2015

(54) PREDICTION PROGRAM, PREDICTION APPARATUS, AND PREDICTION METHOD

(71) Applicant: FUJITSU LIMITED, Kawasaki-shi (JP)

(72) Inventors: Kazuyuki Sakai, Nissin (JP); Daiki Hanawa, Kawasaki (JP); Hiroyuki Fujie, Yokohama (JP); Kouji Abe, Kawasaki (JP)

(21) Appl. No.: 14/665,342

(22) Filed: Mar. 23, 2015

(30) Foreign Application Priority Data
Mar. 31, 2014 (JP) 2014-071195

(51) Int. Cl. G06N 5/04

(52) U.S. Cl. CPC G06N 5/04

(57) ABSTRACT

A non-transitory computer-readable storage medium storing a prediction program that causes a computer to execute a process includes storing accumulated information in a storage unit, in association with a task having previously occurred, the task being a process that needs work performed by an operator, from among a plurality of operation processes executed by an information processing apparatus, the accumulated information including a status information on the information processing apparatus obtained at a time of execution of a determination process from which subsequent processes branch depending on a determination result and which is executed before the task, and a branching result of the determination process and predicting whether the task is to occur after a predetermined timing based on the status information on the information processing apparatus obtained at the predetermined timing and the accumulated information.

### CROSS-REFERENCE TO RELATED APPLICATION

This application is based upon and claims the benefit of priority of the prior Japanese Patent Application No. 2014-071195, filed on Mar. 31, 2014, the entire contents of which are incorporated herein by reference.

### FIELD

The present invention relates to a prediction program, a prediction apparatus, and a prediction method.

### BACKGROUND

Business systems (for example, customer management systems) need to detect an abnormality early which occurs while the system is in operation to expeditiously deal with the abnormality. Furthermore, to prevent a possible abnormality, for example, checks of various parameters (hereinafter referred to as operation processes) need to be periodically executed. The operation processes include, for example, processes from which subsequent processes branch depending on a situation (hereinafter referred to as determination processes) and processes that need judgment or operation performed by an operator (human being) depending on the situation (hereinafter referred to as tasks).

For such operation processes, a technique is present which automatically executes processes that can be automated, in accordance with a preset work flow, and which, for tasks, manages a schedule to prompt an operator to perform work (see, for example, Japanese Patent Application Laid-open No. 2004-13769, Japanese Patent Application Laid-open No. 2001-155062, and Japanese Patent Application Laid-open No. H10-97573).

### SUMMARY

The above-described technique allows the operator to recognize time to perform a task (time when the task is to occur). However, depending on task occurrence timing, the task that needs to be processed within a certain time may exceed the operator's processing capacity. Thus, the operator needs to pre-recognize whether the task is to occur in order to prevent a delay in the process and subsequent processes.

Furthermore, whether or not the task is to occur depends on, for example, the branching result of the determination process. The branching result of the determination process varies depending on the situation at the time of execution of the determination process. Thus, predetermining whether or not the task is to occur is difficult.

According to an aspect of the embodiments, a non-transitory computer-readable storage medium storing a prediction program that causes a computer to execute a process includes: storing accumulated information in a storage unit, in association with a task having previously occurred, the task being a process that needs work performed by an operator, from among a plurality of operation processes executed by an information processing apparatus, the accumulated information including a status information on the information processing apparatus obtained at a time of execution of a determination process from which subsequent processes branch depending on a determination result and which is executed before a task to be predicted, and a branching result of the determination process; and predicting whether the task is to occur after a predetermined timing based on the status information on the information processing apparatus obtained at the predetermined timing and the accumulated information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting a hardware configuration of an information processing apparatus

FIG. 2 is a functional block diagram of the information processing apparatus depicted in FIG. 1.

FIG. 3 is a diagram illustrating information stored in a storage medium 103 depicted in FIG. 1.

FIG. 4 is a diagram illustrating a specific example of the automatic execution process.

FIG. 5 is a flowchart illustrating an accumulated information storage process and a task occurrence prediction process according to the first embodiment.

FIG. 6 is a diagram illustrating the accumulated information storage process and the task occurrence prediction process.

FIG. 7 is a diagram illustrating the status information on the monitoring target server group.

FIG. 8 is a diagram illustrating the accumulated information on the monitoring target server group.

FIG. 9 is a flowchart illustrating the details of the accumulated information storage process according to the first embodiment.

FIG. 10 is a flowchart illustrating the details of the task occurrence prediction process in the first embodiment.

FIG. 11 is a diagram illustrating the accumulated information in the monitoring target server group.

FIG. 12 is a diagram illustrating the boundary line.

FIG. 13 is a diagram illustrating a prediction value.

FIG. 14 is a diagram illustrating a prediction value.

FIG. 15 is a flowchart illustrating the normal-route selection process.

FIG. 16A, FIG. 16B and FIG. 16C are diagrams illustrating selection of a normal route.

FIG. 17 and FIG. 18 are flowcharts illustrating the abnormal-route exclusion process.

FIG. 19 is a flowchart illustrating the task time prediction process.

FIG. 20 is a diagram illustrating the execution history of nodes.

FIG. 21 is a flowchart illustrating the task time limit adjustment process.

FIG. 22 is a diagram illustrating a time limit on occurrence of a task.

FIG. 23 is a diagram depicting a hardware configuration of an information processing apparatus according to the second embodiment.

### DESCRIPTION OF EMBODIMENTS

Embodiments of the present invention will be described below in accordance with the drawings. However, the technical scope of the present invention is not limited to the embodiments and includes matters recited in the claims and equivalents thereto. First, a hardware configuration of an information processing system will be described.

[Configuration of Information Processing Apparatus]

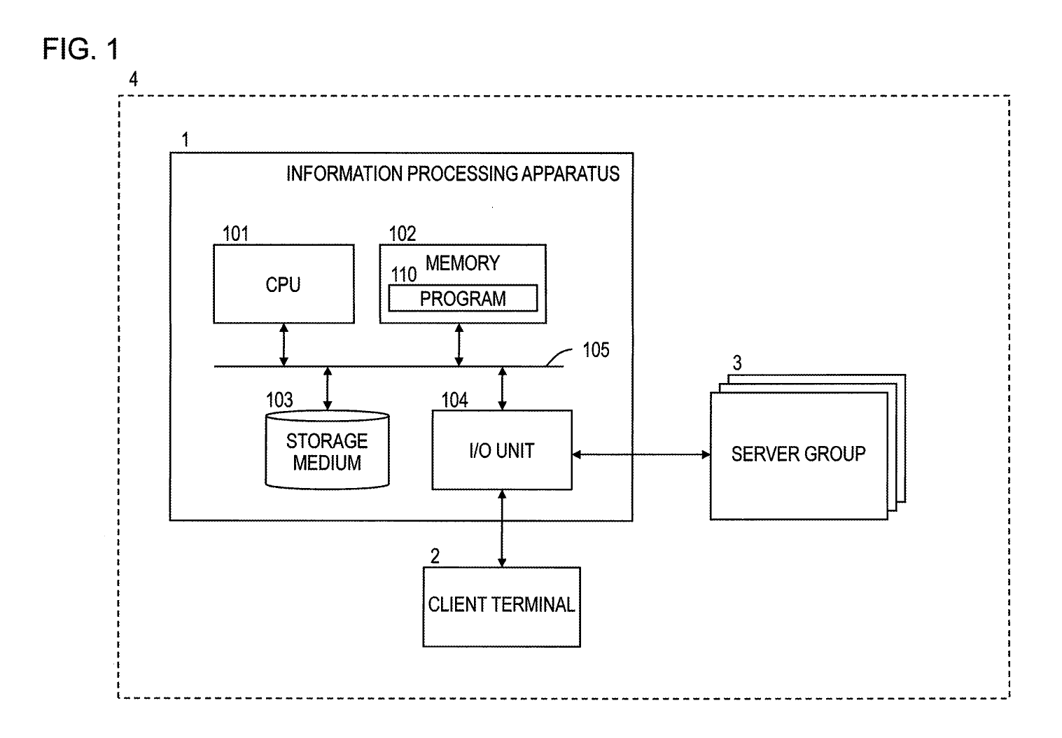

FIG. 1 is a diagram depicting a hardware configuration of an information processing apparatus. An information processing apparatus 1 (hereinafter also referred to as an information management apparatus 1) is connected to a client terminal 2 (hereinafter also referred to as a console terminal 2) and a server group 3 (hereinafter also referred to as a monitoring target server group 3 or a server 3) and can access each of the client terminal 2 and the server group 3. In the example in FIG. 1, the information processing apparatus 1, the client terminal 2, and the server group 3 are provided in a data center 4.

The information processing apparatus 1, for example, monitors an operation status of the server group 3 that is in operation (a state in which the server group 3 is serving a customer). Specifically, the information processing apparatus 1 monitors the operation status of the server group 3 by executing a plurality of operation processes for monitoring various parameters indicating the operation status of the server group 3.

The client terminal 2 is a terminal that displays the operation status acquired by the information processing apparatus 1 by monitoring the server group 3. Furthermore, the client terminal 2 activates an alarm when, for example, the information processing apparatus 1 detects an abnormality in the server group 3. An operator in the data center 4 checks the client terminal 2 to identify the operation status of the server group 3.

The server group 3, for example, periodically transmits information on the operation status of the server group 3 to the information processing apparatus 1. The information processing apparatus 1 may monitor the operation status of the server group 3 based on the transmitted information on the operation status.

The information processing apparatus 1 has a CPU 101 that is a processor, a memory 102, a storage medium 103 (hereinafter also referred to as a storage unit 103), and an external interface (I/O unit) 104. The CPU 101, the memory 102, the storage medium 103, and the external interface 104 are connected together via a bus 105.

The storage medium 103, for example, stores a program 110 for predicting whether a task is to occur. Furthermore, the storage medium 103, for example, stores information used to execute the program 110. When executing the program 110, the CPU 101 loads the program 110 into the memory 102 and cooperates with the program 110 in executing a process of predicting whether the task is to occur.

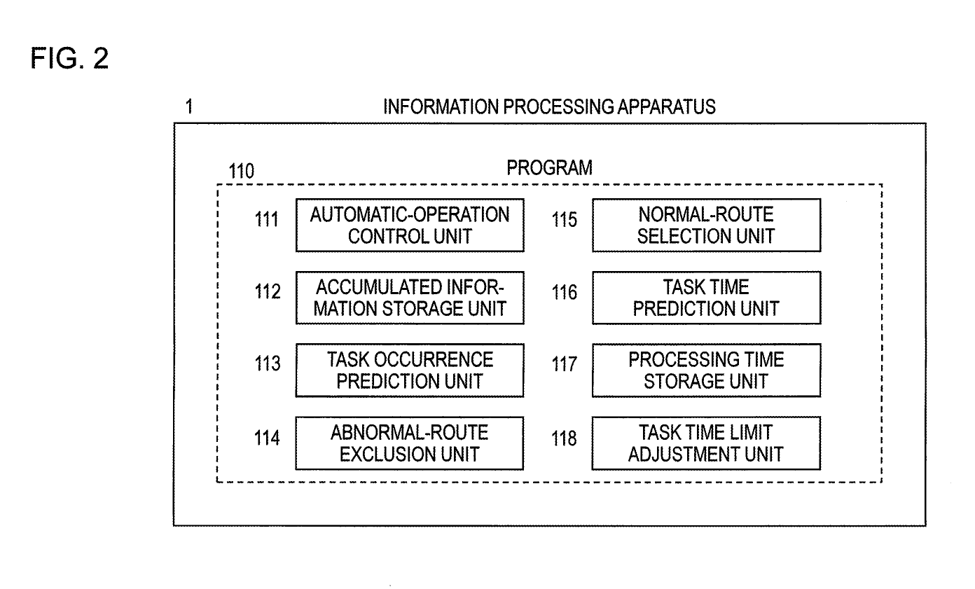

FIG. 2 is a functional block diagram of the information processing apparatus depicted in FIG. 1. As depicted in FIG. 2, the program 110 in the information processing apparatus 1 has, for example, an automatic-operation control unit 111, an accumulated information storage unit 112 (a process executed by the accumulated information storage unit 112 is hereinafter also referred to as a storage process), and a task occurrence prediction unit 113 (hereinafter also referred to as a prediction unit 113; a process executed by the task occurrence prediction unit 113 is hereinafter also referred to as a prediction process). Furthermore, the program 110 in the information processing apparatus 1 has, for example, an abnormal-route exclusion unit 114 (hereinafter also referred to as a route exclusion unit 114; a process executed by the abnormal-route exclusion unit 114 is hereinafter also referred to as a route exclusion process) and a normal-route selection unit 115 (hereinafter also referred to as a route selection unit 115; a process executed by the normal-route selection unit 115 is hereinafter also referred to as a route selection process). Additionally, the program 110 in the information processing apparatus 1 includes, for example, a task time prediction unit 116 (hereinafter also referred to as an occurrence time prediction unit 116; a process executed by the task time prediction unit 116 is hereinafter also referred to as an occurrence time prediction process), a processing time storage unit 117 (hereinafter also referred to as a time storage unit 117; a process executed by the processing time storage unit 117 is hereinafter also referred to as a time storage process), and a task time limit adjustment unit 118.

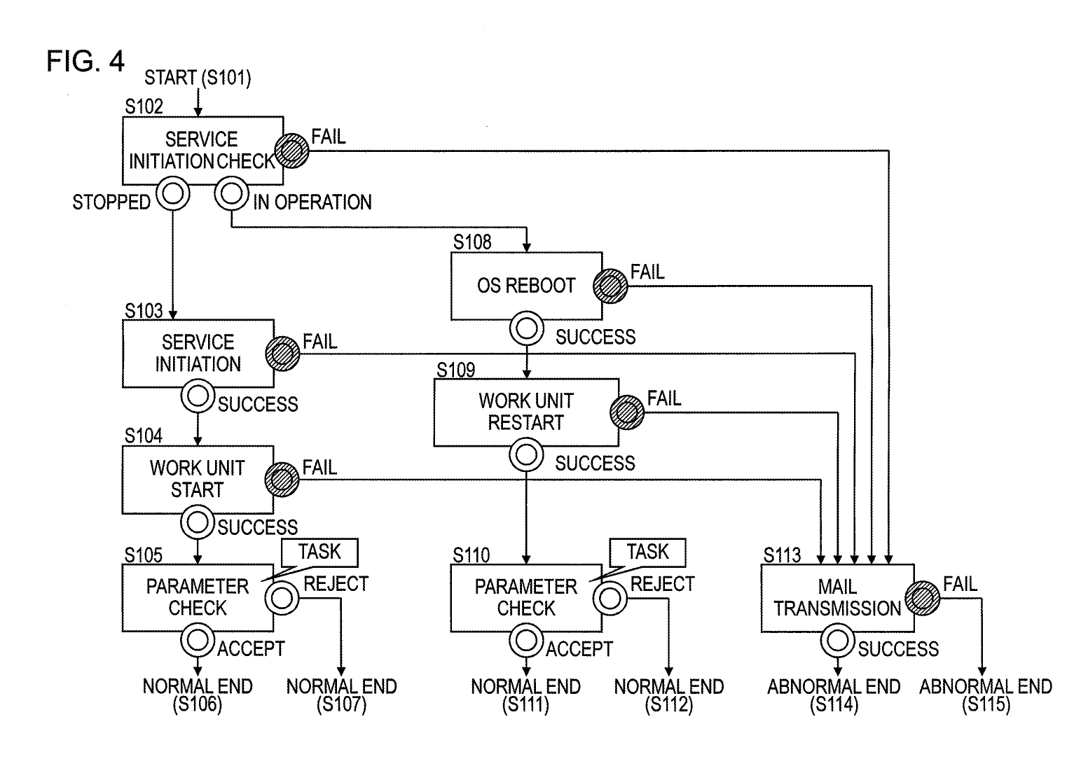

The automatic-operation control unit 111 prepares an automatic-operation schedule (hereinafter also referred to as an automatic execution process) according to which operation processes are executed to automatically execute operation processes that can be automatically executed. An automatic execution process created by the automatic-operation control unit 111 will be described with reference to FIG. 4.

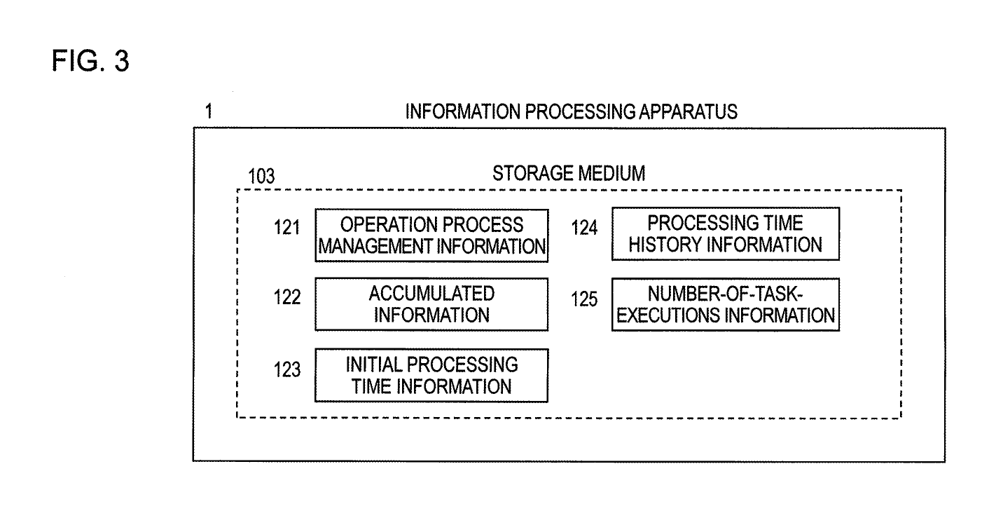

For a task having previously occurred, the accumulated information storage unit 112 stores accumulated information 122 resulting from association, with the task, of the status information on the status of the information processing apparatus 1 at the time of execution of a determination process from which subsequent processes branch depending on a determination result and which is executed before the task, and the branching result of the determination process. The accumulated information 122 will be described with reference to FIG. 3.

Based on the status information on the information processing apparatus 1 at a predetermined timing and the accumulated information stored in the accumulated information storage unit 112, the task occurrence prediction unit 113 predicts whether the task is to occur after the predetermined timing.

The abnormal-route exclusion unit 114 excludes, from among execution routes corresponding to the order of execution of the operation processes possibly executed by the information processing apparatus 1, an execution route which is passed when the branching result of the determination process is abnormal. The task occurrence prediction unit 113, for example, performs prediction of whether the task is to occur, on execution routes that are not excluded by the abnormal-route exclusion unit 114.

The normal-route selection unit 115 selects a single execution route that meets a predetermined condition when a plurality of execution routes are present which have not been excluded by the abnormal-route exclusion unit 114. The task occurrence prediction unit 113, for example, performs prediction of whether the task is to occur, on the execution route selected by the normal-route selection unit 115.

The task time prediction unit 116 predicts a timing when the task is to occur by calculating the sum of the processing time of the operation processes executed before the task. Furthermore, the processing time storage unit 117 stores the processing time of the executed operation processes (hereinafter also referred to as processing time history information 124). The task time prediction unit 116, for example, calculates the sum of the processing time based on the processing time history information 124 stored in the processing time storage unit 117. Additionally, the task time limit adjustment unit 118 warns an operator when the time when the task is to occur that is predicted by the task time prediction unit 116 follows an occurrence time limit (or a process completion time limit) for the task. Alternatively, the task time limit adjustment unit 118 corrects the occurrence time of the task.

FIG. 3 is a diagram illustrating information stored in a storage medium 103 depicted in FIG. 1. As depicted in FIG. 3, the storage medium 103 in the information processing apparatus 1 stores, for example, operation process management information 121, the accumulated information 122, initial processing time information 123, the processing time history information 124, and number-of-task-executions information 125.

The operation process management information 121 is information on operation processes which is used by the automatic-operation control unit 111 to create an automatic execution process. Furthermore, the accumulated information 122 is information resulting from association, with a task, of the above-described status information on the information processing apparatus 1 and the branching result of the determination process. The accumulated information 122 is stored in the accumulated information storage unit 112. Additionally, the initial processing time information 123 is an initial value for the processing time of each operation process. The processing time history information 124 is history information on the processing time of previously executed operation processes. In addition, the number-of-task-executions information 125 is information on the number of times that each task is executed during an automatic execution process.

[Automatic Execution Process]

Now, the automatic execution process created by the automatic-operation control unit 111 will be described. FIG. 4 is a diagram illustrating a specific example of the automatic execution process.

The automatic-operation control unit 111 creates an automatic operation process based on input information pre-input by the operator or information on operation processes stored in the operation process management information 121. The automatic operation process specifies the order of execution of operation processes and the execution time of the operation processes. In accordance with the automatic operation process, the automatic-operation control unit 111 executes operation processes that can be automatically executed (hereinafter also referred to as operation manipulation components) based on a specified order of execution and a specified execution time. Furthermore, tasks that are not automatically executed are, for example, displayed on the client terminal 2 to prompt the operator to execute the task.

In the automatic execution process in the example in FIG. 4, a start 5101 is a node indicative of a start position of the automatic execution process. Furthermore, service initiation check S102, service initiation S103, work unit start S104, parameter check S105, OS reboot S108, work unit restart S109, parameter check S110, and mail transmission S113 are nodes indicative of operation processes intended to monitor the operation status of the server group 3. Additionally, normal ends S106 and S111 and abnormal ends S107, S112, S114, and S115 are nodes indicative of end positions of automatic execution process.

Furthermore, each of the operation processes has one or more exits. In the example in FIG. 4, the exit is depicted by a double circle. For example, the service initiation check (S102) has three exits with attributes “stopped”, “in operation”, and “fail”, respectively. An exit to which the process proceeds when the execution of the operation processes ends without any problem is hereinafter referred to as a normality-related exit. An exit to which the process proceeds when the execution of the operation processes fails is hereinafter referred to as an abnormality-related exit. In the example in FIG. 4, the normality-related exit is depicted by a double circle without half-tone screening. The abnormality-related exit is depicted by a double circle with half-tone screening.

The operation process is a process executed by the information processing apparatus 1 to actually operate the monitoring target server group 3. The automatic-operation control unit 111 sequentially executes operation processes in accordance with the automatic execution process. Furthermore, the operation processes include determination processes from which subsequent processes branch depending on the determination result. Thus, the execution route corresponding to the order of operation processes executed by the automatic-operation control unit 111 varies depending on the results of branching from determination processes. In the present embodiment, the determination process is an operation manipulation component and is an operation process with two or more normality-related exits. In the example in FIG. 4, the service initiation check (S102) with the normality-related exits “stopped” and “in operation” is a determination process.

In the example in FIG. 4, the automatic-operation control unit 111 performs a service initiation check in the monitoring target server group 3 in accordance with the automatic execution process (S102). The node indicative of the service initiation check (S102) has three exits with the attributes “stopped”, “in operation”, and “fail”.

Upon determining that the service is stopped (“stopped” in S102), the automatic-operation control unit 111 proceeds to a route connecting to the exit with the attribute “stopped”. Then, the automatic-operation control unit 111 initiates the service in accordance with the automatic execution process (S103). Moreover, the automatic-operation control unit 111 proceeds to a route connecting to the exit with the attribute “success” to start a work unit (S104). Then, the automatic-operation control unit 111 proceeds to a route connecting to the exit with the attribute “success” to prompt the operator to perform a parameter check (S105). Then, when the operator inputs the result of the parameter check (accept or reject), the automatic-operation control unit 111 determines that the automatic execution process in the example in FIG. 4 has ended normally (S106 and S107).

On the other hand, upon determining that the service is in operation as a result of the service initiation check performed on the monitoring target server group 3 in accordance with the automatic execution process (“in operation” in S102), the automatic-operation control unit 111 proceeds to a route connecting to the exit with the attribute “in operation”. Then, the automatic-operation control unit 111 reboots the OS (S108). Moreover, the automatic-operation control unit 111 proceeds to a route connecting to the exit with the attribute “success” to restart the work unit (S109). Then, the automatic-operation control unit 111 proceeds to a route connecting to the exit with the attribute “success” to prompt the operator to perform a parameter check (S110). Then, when the operator inputs the result of the parameter check (accept or reject), the automatic-operation control unit 111 determines that the automatic execution process in the example in FIG. 4 has ended normally (S111 and S112).

Furthermore, upon failing in the execution of the operation process in S102 to S104, S108, or S109, the automatic-operation control unit 111 proceeds, in each case, to a route connecting to the exit with the attribute “fail”. In this case, for example, the automatic-operation control unit 111 transmits the status to a person in charge of development of the operation process by mail (S113). Then, upon completing the mail transmission (S113), the automatic-operation control unit 111 determines, in the example in FIG. 4, that the automatic execution process has ended abnormally, regardless of whether or not the mail transmission has succeeded (S114 and S115).

The automatic execution process in FIG. 4 has the parameter check (S105) and the parameter check (S110) as tasks. Furthermore, whether or not the parameter check (S105) and the parameter check (S110) are to occur depends on the branching result of the service initiation check (S102). That is, the execution route corresponding to the order of execution of operation processes may vary depending on the results of branching from determination processes. Therefore, the operator has difficulty predicting the execution route along which the operation is to be actually performed. Thus, the operator needs to pre-recognize a task that may occur in order to prevent a delay in subsequent processes due to concentration of work.

Thus, in the present embodiment, the status information obtained at the time of execution of a determination process that is executed before a task that is a process needing work performed by the operator and the branching result of the determination process are stored in association with the task, to predict the task that is to occur in the future.

### First Embodiment

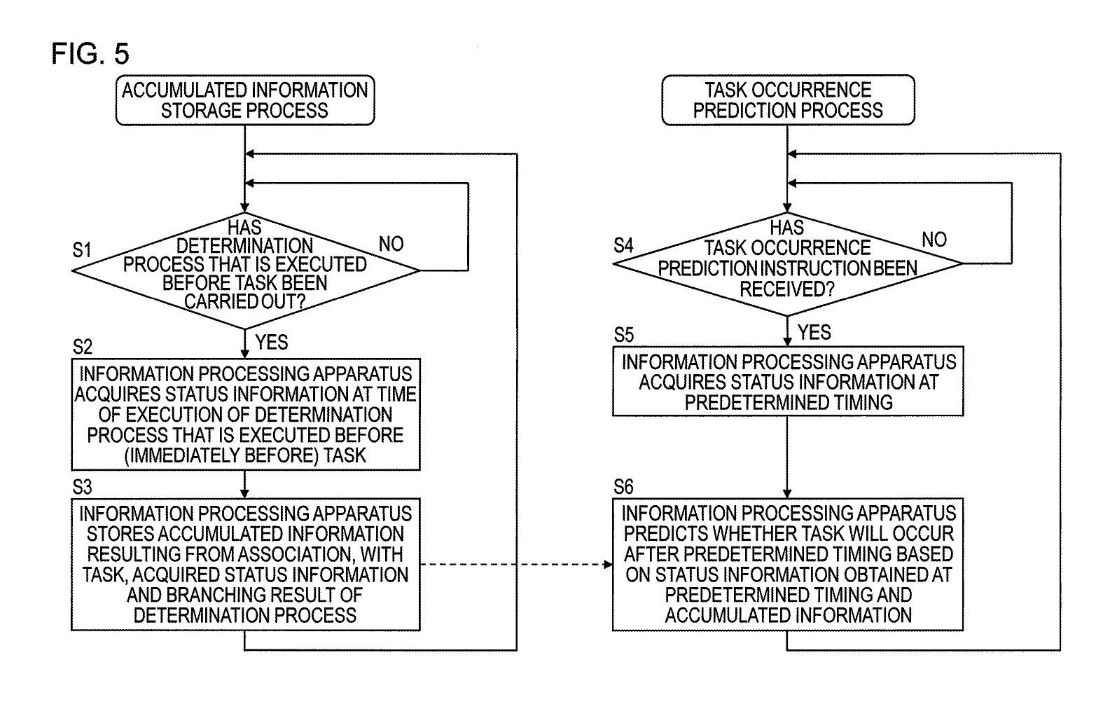

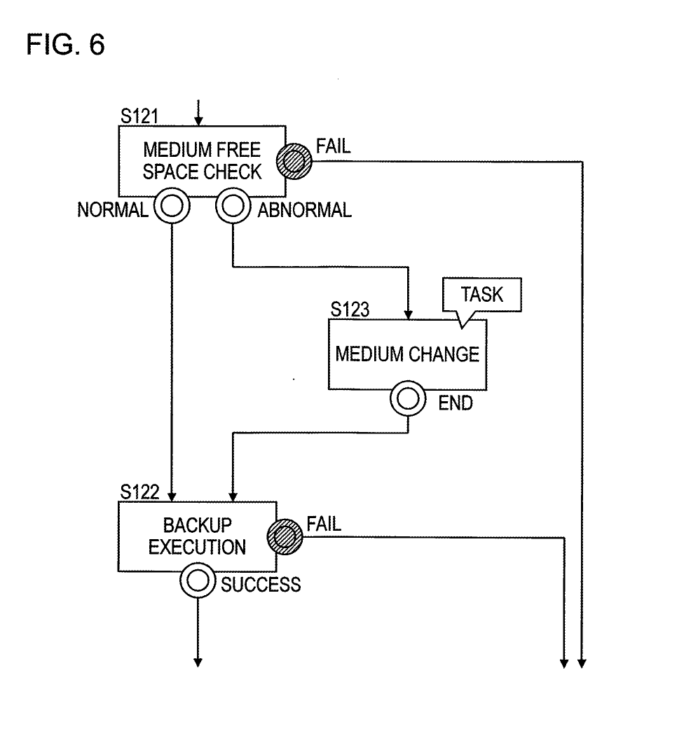

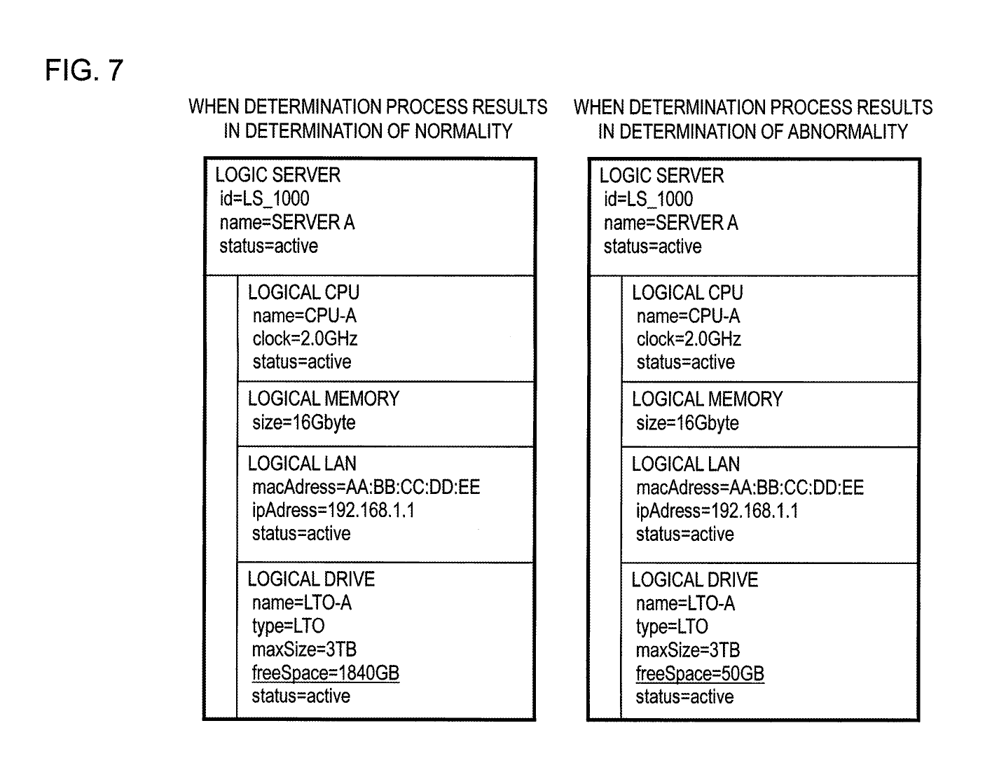

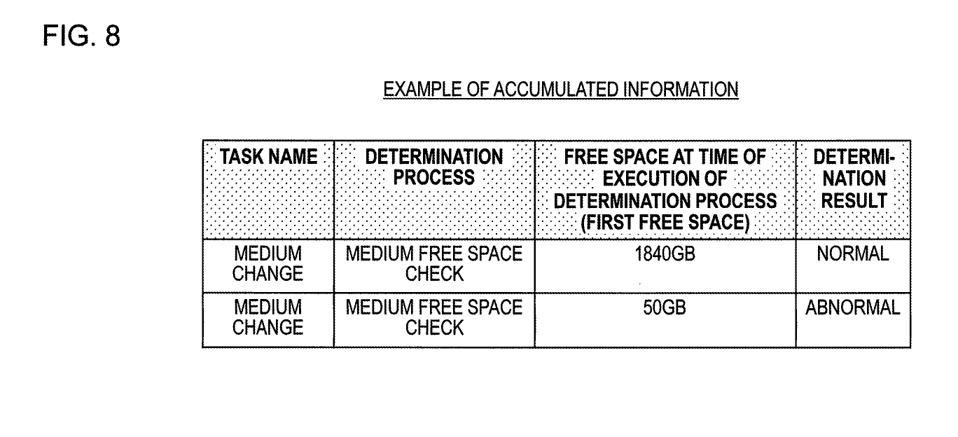

First, a first embodiment will be described. FIG. 5 is a flowchart illustrating an accumulated information storage process and a task occurrence prediction process according to the first embodiment. FIG. 6 is a diagram illustrating the accumulated information storage process and the task occurrence prediction process. FIG. 7 is a diagram illustrating the status information on the monitoring target server group. Furthermore, FIG. 8 is a diagram illustrating the accumulated information on the monitoring target server group. The accumulated information storage process and task occurrence prediction process in FIG. 5 will be described with reference to FIGS. 6 to 8.

[Accumulated Information Storage Process]

The accumulated information storage unit 112 stand by until a determination process that is executed before a prediction target task is carried out (NO in S1). Then, when the determination process is carried out (YES in S1), the accumulated information storage unit 112 in the information processing apparatus 1 acquires the status information on the monitoring target server group 3 at the time of execution of the determination process that is executed before the task (S2).

The status information is information acquired based on the operation status of the monitoring target server group 3. The status information corresponds to, for example, the operating rate of a CPU, the line speed of communication with other servers, or a free space in a backup medium. A case where the status information is the free space in the backup medium will be described by way of example.

FIG. 6 is a diagram of a part of the automatic execution process which is related to a backup process. In FIG. 6, the automatic-operation control unit 111 in the information processing apparatus 1 checks for a medium free space in accordance with the automatic execution process (S121). A check for a medium free space (S121) has three exits with the attributes “normal”, “abnormal”, and “fail”. Upon determining that a sufficient medium free space for a backup process remains and that no medium change is needed (S121), the automatic-operation control unit 111 proceeds to a route connecting to the exit with the attribute “normal”. Then, the automatic-operation control unit 111 performs backup in accordance with the automatic execution process (S122).

On the other hand, upon determining that a medium change needs to be performed because a sufficient medium free space does not remain and the backup process is expected not to complete normally (S121), the automatic-operation control unit 111 proceeds to a route connecting to the exit with the attribute “abnormal”. Then, the automatic-operation control unit 111 performs a medium change (S123) and then carries out backup in accordance with the automatic execution process (S122).

In the example in FIG. 6, the medium change (S123) is a task. The determination process that is executed before the task in S1 corresponds, in the example in FIG. 6, to the check for a medium free space (S121). The acquisition of the status information will be described based on an example in FIG. 7.

The left side of FIG. 7 depicts the operating status of the server group 3 at the time of execution of the determination process when the determination process ends normally. The right side of FIG. 7 depicts the operating status of the server group 3 at the time of execution of the determination process when the determination process ends abnormally. In the example in FIG. 7, the “freeSpace (medium free space)” is an item with a value varying between the normal end of the determination process (left side of FIG. 7) and the abnormal end of the determination process (right side of FIG. 7). Moreover, the check for a medium free space (S121) is the determination process in the example in FIG. 6. This indicates that the value of “freeSpace” affects the branching result of the determination process. Hence, in the example in FIG. 6, the accumulated information storage unit 112 acquires the value of “freeSpace” as the status information.

The process will further be described with reference to FIG. 5. The accumulated information storage unit 112 stores the accumulated information 122 resulting from association, with the task, of the acquired status information and the branching result of the determination process, in the storage medium 103 as the accumulated information 122 (S3).

The accumulated information 122 results from association, with a task on which occurrence prediction is to be performed, of the status information on the status of the monitoring target server group 3 obtained at the time of execution of the determination process that is executed before the take on which occurrence prediction is to be performed and the branching result of the determination process. A specific example of the accumulated information will be described.

FIG. 8 is an example of the accumulated information associated with the status information in the example in FIG. 7. In the example in the left side of FIG. 7, the branching result of the check for a medium free space (S121) is “normal” when the value of “freeSpace”, which is the status information on the monitoring target server group 3, is “1840 GB”. Moreover, in the example in the right side of FIG. 7, the branching result of the check for a medium free space (S121) is “abnormal” when the value of “freeSpace”, which is the status information on the monitoring target server group 3, is “50 GB”. Thus, as depicted in FIG. 8, the accumulated information storage unit 112 stores the information “1840 GB” and “normal” in the accumulated information 122 in association with the information “medium change”, which is a task on which occurrence prediction is to be preformed. Furthermore, the accumulated information storage unit 112 stores the information “50 GB” and “abnormal” in the accumulated information 122 in association with the information “medium change”.

That is, in the example in FIG. 8, each time the check for a medium free space (S121), which is a determination process, is performed, the accumulated information storage unit 112 acquires “freeSpace” as the status information and stores the determination result of the check for a medium free space (S121) and the “medium change”, a prediction target task, in the accumulated information 122 in association with each other.

The determination process that is executed before the prediction target task is carried out before the prediction target task, and the branching result of the determination process affects occurrence of the task. Thus, when a plurality of determination processes that affects occurrence of the task is present on the automatic execution process, the accumulated information storage unit 112 may acquire the status information on the statuses of the plurality of determination processes at the time of execution of the processes. Alternatively, when a plurality of determination processes that affects occurrence of the task is present, the accumulated information storage unit 112 may acquire only the status information on a determination process with an execution timing temporally closest to the prediction target task (the last determination process).

[Task Generation Prediction Process]

The task occurrence prediction unit 113 in the information processing apparatus 1 stands by until upon receiving a task occurrence prediction instruction (NO in S4). Then, upon receiving a task occurrence prediction instruction (YES in S4), the task occurrence prediction unit 113 acquires status information on the status at a predetermined timing (S5). The task occurrence instruction is, for example, manually given by the operator via the client terminal 2. Furthermore, for example, a timer may be provided in the information processing apparatus 1 so that the task occurrence prediction unit 113 can start predicting whether the task is to occur, based on the time on the timer.

Then, based on the acquired status information obtained at the predetermined timing and the accumulated information 122 stored in the accumulated information storage unit 112, the task occurrence prediction unit 113 predicts whether the task is to occur after the predetermined timing (S6).

The predetermined timing in S5 and S6 precedes occurrence of the prediction target task. Specifically, the predetermined timing corresponds to each operator's operation start time. That is, the task occurrence prediction unit 113 acquires, at the operation start time (for example, 10 a.m.) of an operator who may execute a task within the operator's operation time, “freeSpace”, the status information on the status of the monitoring target server group 3 at the operation start time (S5). As the information on the operation time and the operation start time, for example, the task occurrence prediction unit 113 may use information pre-registered in the information processing apparatus 1 by the operator.

Then, based on the acquired “freeSpace” and accumulated information 122, the task occurrence prediction unit 113 predicts the branching result of the determination process before the prediction target task (task that occurs after the predetermined timing) occurring within the operator's operation time (for example, 10 a.m. to 7 p.m.). Then, based on the predicted branching result of the determination process, the task occurrence prediction unit 113 predicts whether the prediction target task is to occur (S6). When the operation start time varies depending on the operator, whether the task is to occur after each operation start time is predicted based on the information obtained at the operation start time and the accumulated information 122.

The status information obtained at the predetermined timing may be, for example, the latest information of the status information that can be acquired by the task occurrence prediction unit 113. Furthermore, the status information obtained at the predetermined timing may be, for example, acquired by the task occurrence prediction unit 113 in response to reception of a task occurrence prediction instruction. A specific example of task occurrence prediction will be described based on the accumulated information 122 in the example in FIG. 8.

In the example in FIG. 8, the accumulated information 122 stores “1840 GB”, the value of “freeSpace” present at the time of the check for a medium free space (S121) and “normal”, the branching result of the determination process, in association with the task “medium change”. Moreover, “50 GB” and “abnormal” are stored in association with the task “medium change”. Thus, when the medium free space is assumed not to vary between the operator's operation start time (predetermined timing) and the determination process, the task occurrence prediction unit 113 can predict that the branching result of the determination process is to be “normal” when the value of “freeSpace” present at the operation start time is equal to or larger than 1840 GB. Furthermore, the task occurrence prediction unit 113 can predict that the branching result of the determination process is to be “abnormal” when the value of “freeSpace” present at the operator's operation start time is equal to or larger than 50 GB.

Specifically, upon acquiring “2000 GB” as “freeSpace” present at the operation start time, the task occurrence prediction unit 113 predicts that the branching result of the determination process is to be “normal” because “2000 GB” is more than “1840 GB”, which is determined to be “normal”.

On the other hand, upon acquiring “10 GB” as “freeSpace” present at the operation start time, the task occurrence prediction unit 113 predicts that the branching result of the determination process is to be “abnormal” because “10 GB” is less than “50 GB”, which is determined to be “abnormal”. Thus, the task occurrence prediction unit 113 predicts that the task “medium change” is to occur.

Furthermore, it is assumed that the task occurrence prediction unit 113 acquires “1200 GB” as “freeSpace” present at the operation start time. Then, since “1200 GB” is a value midway between “1840 GB”, which is determined to be “normal”, and “50 GB”, which is determined to be “abnormal”, the task occurrence prediction unit 113 fails to predict the branching result of the determination process based on the accumulated information 122 in the example in FIG. 8. Since “1200 GB” is closer to “1840 GB” than to “50 GB”, the task occurrence prediction unit 113 may predict that the branching result of the determination process is to be “normal”.

That is, the task occurrence prediction unit 113 checks the information stored in the accumulated information 122 based on the status information obtained at the predetermined timing. The task occurrence prediction unit 113 thus predicts whether the task is to occur by utilizing information in the accumulated information 122 which allows prediction of whether the task is to occur after the predetermined timing.

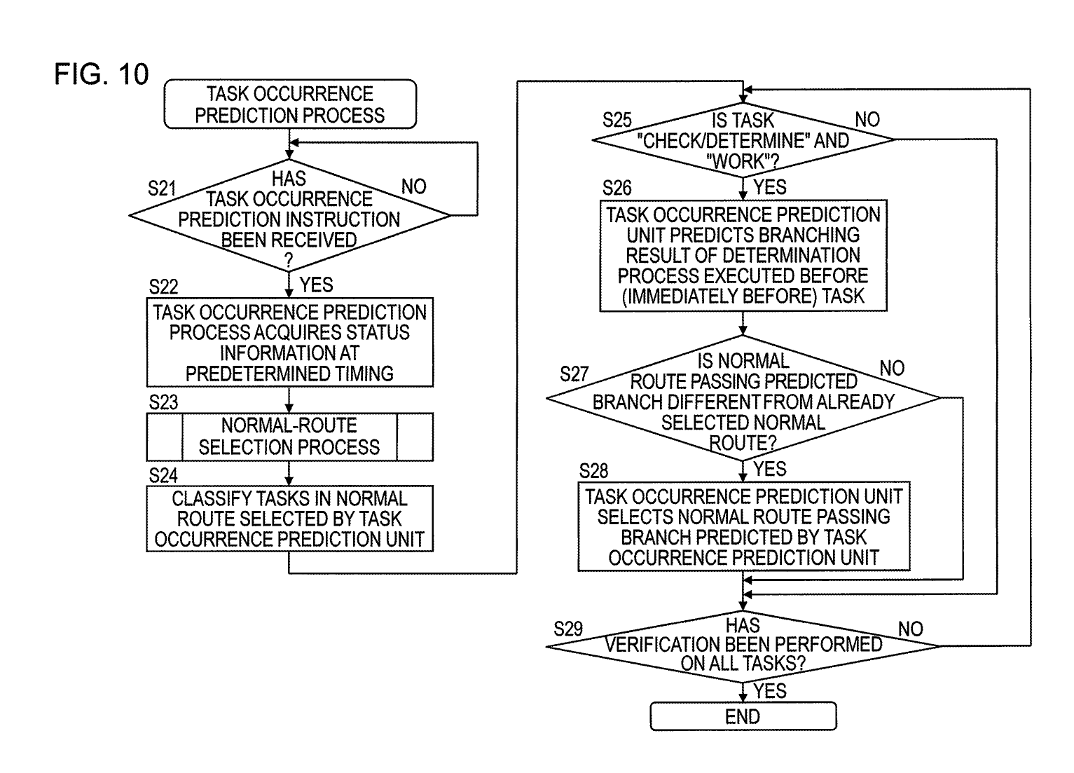

Furthermore, when the medium free space changes between the operator's operation start time (predetermined timing) and the time of the determination process, the task occurrence prediction unit 113 may predict whether the task is to occur taking into account the value of a decrease in the medium free space during a period between the predetermined timing and the time of the determination process. Prediction of whether the task is to occur when the medium free space changes during the period between the predetermined timing and the time of the determination process will be described with reference to FIG. 10.

Thus, according to the present embodiment, for a task having previously occurrence, the accumulated information storage unit 112 stores the accumulated information resulting from association, with the task, of the status information obtained at the time of execution of a determination process from which subsequent processes branch depending on the determination result and which is executed before the task, and the branching result of the determination process. Furthermore, based on the status information on the status at the predetermined timing and the accumulated information stored in the accumulated information storage unit 112, the task occurrence prediction unit 113 predicts whether the task is to occur after the predetermined timing. Thus, an execution route along which the actual operation is performed can be predicted, enabling the operator to preliminarily know whether the task is to occur. Consequently, by determining the time zone when work concentrates, the operator can prevent a delay in subsequent processes. Additionally, the operator prevents a delay in subsequent processes and thus need not pre-recognize tasks that may occur. Therefore, the processing load on the operator can be reduced.

[Details of the First Embodiment]

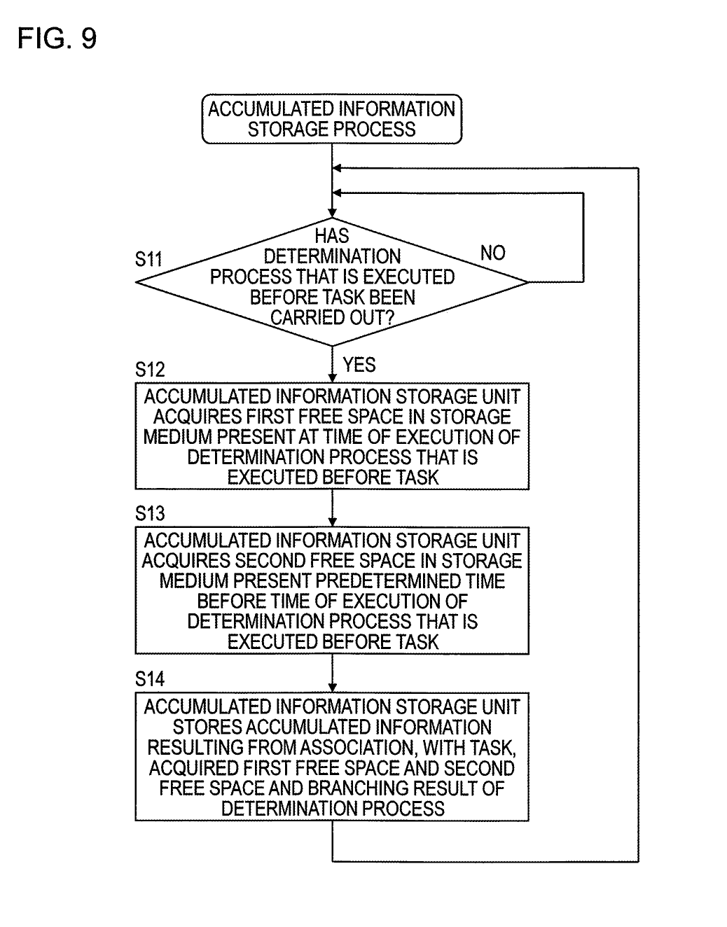

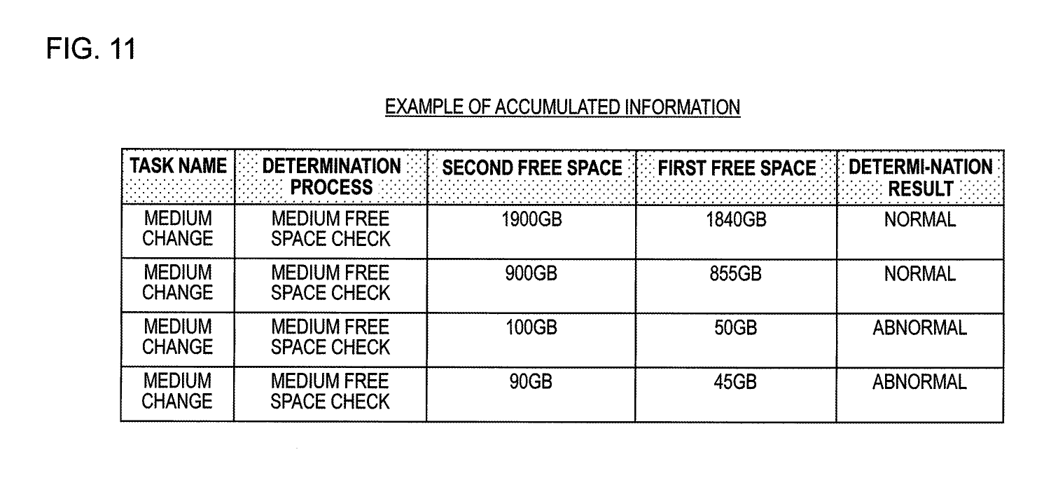

Now, the details of the first embodiment will be described. FIG. 9 is a flowchart illustrating the details of the accumulated information storage process according to the first embodiment. FIG. 10 is a flowchart illustrating the details of the task occurrence prediction process in the first embodiment. Furthermore, FIG. 11 is a diagram illustrating the accumulated information in the monitoring target server group. With reference to FIG. 11, the accumulated information storage process in FIG. 9 and the task occurrence prediction process in FIG. 10 will be described.

[Details of the Accumulated Information Storage Process]

As depicted in FIG. 9, when the determination process that is executed before the occurrence prediction target task is carried out (YES in S11), the accumulated information storage unit 112 in the information processing apparatus 1 acquires a first free space in the storage medium in the monitoring target server group 3 present at the time of execution of the determination process that is executed before the task (S12). Then, the accumulated information storage unit 112 acquires a second free space present in the storage medium a predetermined time before the time of execution of the determination process executed before the occurrence prediction target task (S13). Then, the accumulated information storage unit 112 stores the accumulated information resulting from association, with the task, of the acquired first free space and second free space and the branching result of the determination process as depicted in FIG. 11 (S14).

The accumulated information storage unit 112 may acquire the second free space in the storage medium so as to, for example, set a constant time difference (for example, three hours) between the time of acquisition of the second free space and the time of acquisition of the first free space. Furthermore, the accumulated information storage unit 112 may, for example, acquire the second free space at predetermined times (for example, 10 o'clock and 22 o'clock every day). Moreover, the accumulated information storage unit 112 may, for example, acquire, at the operator's operation start time, the second free space in order to predict tasks that may occur during the operator's operation time.

When the time difference between the time of acquisition of the second free space and the time of acquisition of the first free space is not constant, the accumulated information storage unit 112 may, for example, also store the information obtained at the time of acquisition of the second free space and the time of acquisition of the first free space, in the accumulated information 122. Furthermore, the accumulated information storage unit 112 may, for example, store information on the time difference between the time of acquisition of the second free space and the time of acquisition of the first free space in the accumulated information 122 instead of the information obtained at the time of acquisition of the second free space and the time of acquisition of the first free space.

That is, unlike in the case in FIG. 5, the accumulated information storage unit 112 acquire not only the first free space present in the storage medium at the time of execution of the determination process that is executed before the task but also the second free space present in the storage medium the predetermined time before the execution of the determination process, and stores the first free space and the second free space in the accumulated information 122. Consequently, the task occurrence prediction unit 113 can determine the rate of decrease in the medium free space. Thus, as described below in detail, the task occurrence prediction unit 113 can predict whether the task is to occur even when the medium free space changes after the acquisition of the status information on the monitoring target server group 3 and before the determination process.

[Details of the Task Occurrence Prediction Process]

[S21 to S23 in FIG. 10]

As depicted in FIG. 10, the task occurrence prediction unit 113 in the information processing apparatus 1 stands by until upon receiving a task occurrence prediction instruction (NO in S21). Then, upon receiving a task occurrence prediction instruction (YES in S21), the task occurrence prediction unit 113 in the information processing apparatus 1 acquires the status information at the time of the predetermined timing (S22). The status information has been described with reference to FIG. 5 and will thus not be described below in detail.

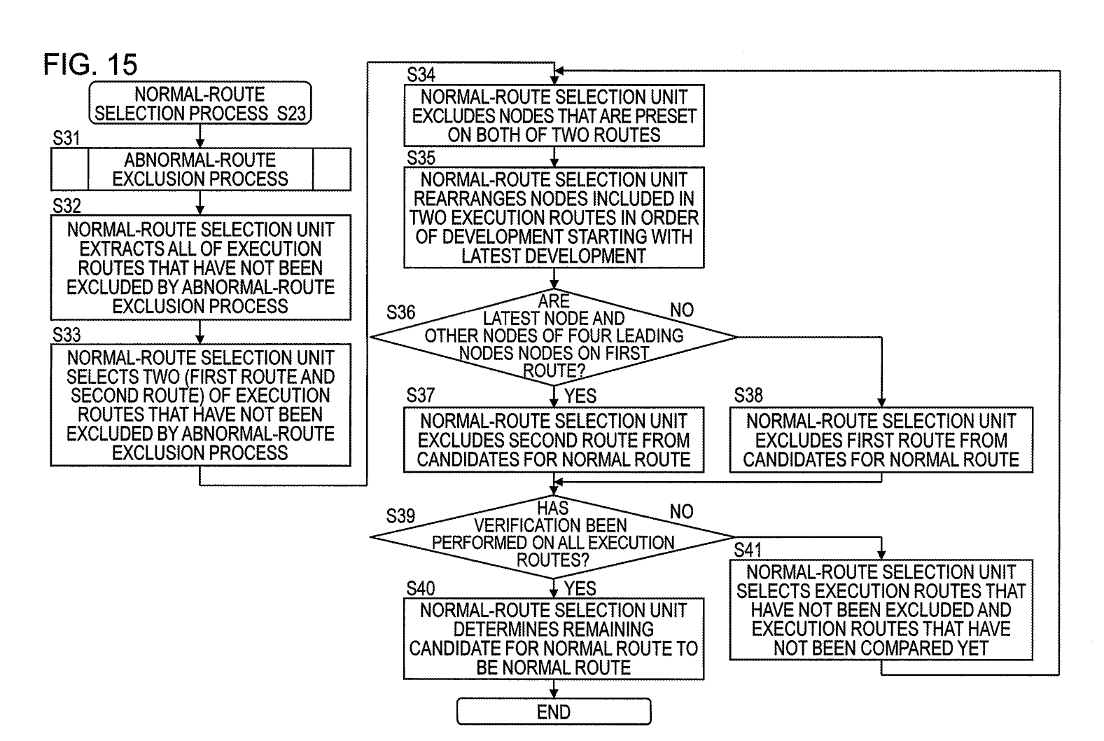

Then, the task occurrence prediction unit 113 executes a normal-route selection process to select one execution route on which whether the task is to occur is predicted (S23). Normal routes are those of the execution routes in the automatic execution process which end normally. That is, the task occurrence prediction unit 113 selects one normal route highly expected to be actually executed. Then, the task occurrence prediction unit 113 predicts whether a task that may occur on the selected normal route is to occur. Thus, the task occurrence prediction unit 113 can predict whether a task highly expected to occur in the actual operation is to occur. The task occurrence prediction unit 113 may predict tasks that may occur, for all the normal routes. Alternatively, the task occurrence prediction unit 113 may predict whether tasks are to occur including those which may occur on those of the routes in the automatic execution process which end abnormally (hereinafter also referred to as abnormal routes). The details of the normal-route selection process (S23) will be described with reference to FIG. 15.

[S24 in FIG. 10]

Then, the task occurrence prediction unit 113 classifies the task on the selected normal route (S24). The tasks may be classified into, for example, “accept”, “parameter input”, “check/determine”, and “work”. The “accept” is, for example, input by the operator upon checking the execution state of the operation manipulation component to find no problem. Furthermore, the “parameter input” is a task in which, for example, the operator inputs parameters, for example, in selecting a monitoring target server group. Additionally, the “check/determine” is a task in which, for example, the operator checks actual machines (monitoring target server group 3) to input determination of whether or not to continue the execution of the process. In addition, the “work” is a task that needs work such as a change of the medium which is done by the operator upon checking for a medium free space.

When, for example, the task is present immediately after the start of the automatic execution process, is provided with a form displaying the values of variables, and further involves a plurality of selections, the task occurrence prediction unit 113 may determine the task to be “accept”. Furthermore, when, for example, an input form for the variables is present, the task occurrence prediction unit 113 may determine the task to be “parameter input”. Alternatively, when, for example, the task is not present immediately after the start of the automatic execution process, is provided with a form displaying the values of variables, and further involves a plurality of selections, the task occurrence prediction unit 113 may determine the task to be “accept”. Additionally, when, for example, a file corresponding to an operational procedure is attached, a hyperlink is present, or the form is described in 10 lines or more, the task occurrence prediction unit 113 may determine the task to be “work”.

Furthermore, the task occurrence prediction unit 113 may, for example, predict whether the task is to occur only for tasks that need a long processing time. In the example in FIG. 10, a case where the task occurrence prediction unit 113 predicts that the task “check/determine” or “work” is to occur.

[S25 and S26 in FIG. 10]

Then, when the task on the normal route selected in S23 is “check/determine” or “work” (YES in S25), then based on the status information obtained at a predetermined timing (for example, the operator's operation start time) and the accumulated information 122 stored in the accumulated information storage unit 112, the task occurrence prediction unit 113 predicts whether the task is to occur after the predetermined timing (S26). The details of prediction of whether the task is to occur will be described below.

[Prediction of Whether the Task is to Occur]

FIG. 11 is a diagram illustrating the accumulated information in the monitoring target server group. FIG. 11 is an example of the accumulated information 122 on the task “medium change” described with reference to FIG. 6 as is the case with the example in FIG. 8. Specifically, the accumulated information 122 in the example in FIG. 11 stores information including the second free space “1900 GB”, the first free space “1840 GB”, and the determination result “normal”, information including the second free space “900 GB”, the first free space “855 GB”, and the determination result “normal”, information including the second free space “100 GB”, the first free space “50 GB”, and the determination result “abnormal”, and information including the second free space “90 GB”, the first free space “45 GB”, and the determination result “normal”. In the example in FIG. 11, the description assumes that the acquisition of the second free space is executed one hour before the acquisition of the first free space (execution of the determination process) in all the cases.

In S26, the task occurrence prediction unit 113 predicts a reference used for the determination in the determination process. Specifically, the task occurrence prediction unit 113 determines a boundary line (hereinafter also referred to as a first line) based on the accumulated information 122. Then, the task occurrence prediction unit 113 predicts whether the task is to occur in the future using the determined boundary line as a prediction reference.

First, the task occurrence prediction unit 113 determines the mean value (hereinafter also referred to as a first value) of the first free spaces in the accumulated information 122 which are determined to be “abnormal”. That is, the following Equation (1) holds true.

First value=the sum of the first free spaces determined to be abnormal/the number of the first free spaces determined to be abnormal (1)

In the example in FIG. 11, the first free spaces determined to be “abnormal” are “50 GB” and “45 GB”. Hence, the task occurrence prediction unit 113 adds “50 GB” and “45 GB” together in accordance with Equation (1). Then, the result is divided by the number of the first free spaces determined to be abnormal, “2”. The first value is thus determined to be “47.5 GB”.

Then, the task occurrence prediction unit 113 determines the value of a change in free space per unit time based on the difference between the first free space in the accumulated information 122 and the second free space corresponding to the first free space. The task occurrence prediction unit 113 then determines the mean value (hereinafter also referred to as a second value) of the determined values of a change in free space. That is, Equations (2) and (3) hold true.

Value of a change in free space per unit time=(first free space−second free space)/time difference between the time of acquisition of the second free space and the time of acquisition of the first free space (2)

Second value=the sum of values of a change in free space per unit time/the number of pieces of information stored in the accumulated information 122 (3)

In the example in FIG. 11, the task occurrence prediction unit 113 subtracts “1900 GB” from “1840 GB” and divides the difference by the time difference between the time of acquisition of the second free space and the time of acquisition of the first free space, “1 hour”, in accordance with Equation (2). Then, the task occurrence prediction unit 113 determines the resultant “−60” to be the value of a change in free space per unit time. Similarly, the task occurrence prediction unit 113 calculates the values of a change in free space per unit time to be “−45”, “−50”, and “−45”, based on the information in the accumulated information 122.

Moreover, the task occurrence prediction unit 113 adds “−60”, “−45”, “−50”, and “−45” in accordance with Equation (3). The task occurrence prediction unit 113 then determines the sum of the values of a change in free space per unit time to be “−200”. The task occurrence prediction unit 113 then divides the calculated sum of the values of a change in free space per unit time, “−200”, by the number of pieces of information (first free space and second free space) stored in the accumulated information 122, “4”. The task occurrence prediction unit 113 thus determines the second value to be “−50”.

Then, the task occurrence prediction unit 113 determines, in a graph in which the axis of abscissas represents the time and the axis of ordinate represents the free space, the first line passing the first value at the time of execution of the determination process and having a gradient of the second value.

When it is preliminarily clear that the time difference between the time of acquisition of the first free space (the time of execution of the determination process) and the time of acquisition of the second free space is constant, the task occurrence prediction unit 113 may determine the second value as illustrated by Equations (4) and (5).

Free space change value=first free space−second free space (4)

Second value=the sum of free space change values/the number of pieces of information stored in the accumulated information 122 (5)

For example, when, for a certain task, the acquisition of the first free space (execution of the determination process) and the acquisition of the second free space are performed at predetermined times every day, the time difference between the time of acquisition of the first free space (the time of execution of the determination process) and the time of acquisition of the second free space in the accumulated information 122 is constant. Thus, by determining the second value using Equations (4) and (5), the task occurrence prediction unit 113 can calculate the second value without determining the value of a change in free space per unit time as in the case of Equations (2) and (3). Thus, the task occurrence prediction unit 113 need not store the information obtained at the time of acquisition of the first free space and the information obtained at the time of acquisition of the second free space, in the accumulated information 122 or the like, in order to determine the value of a change in free space per unit time.

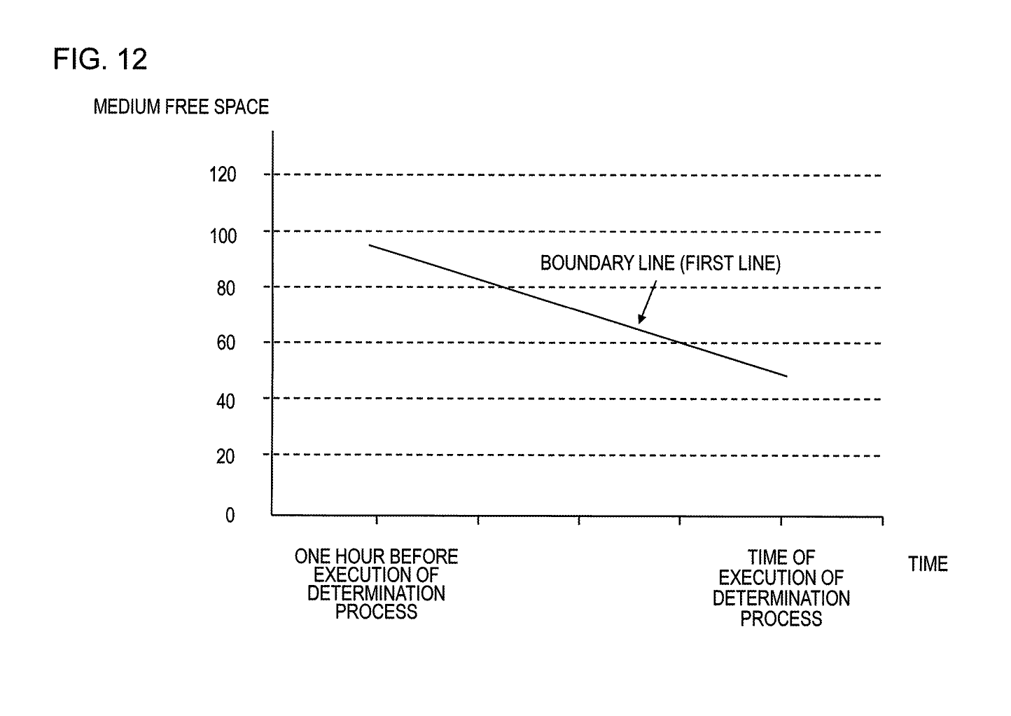

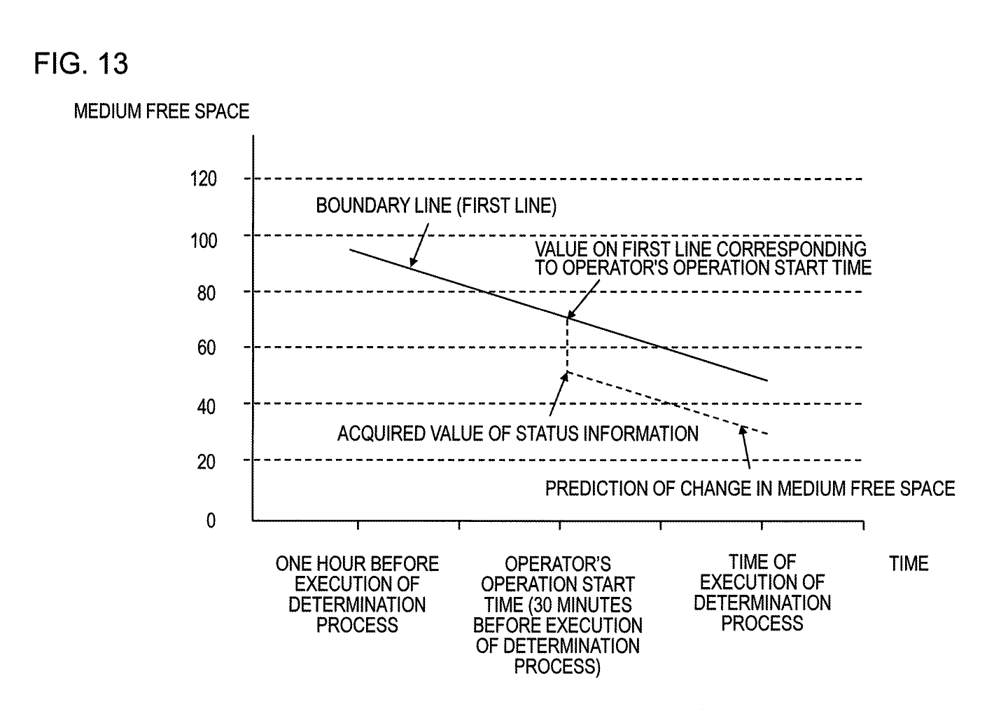

Now, prediction of the branching result of the determination process using the boundary line will be described. FIG. 12 is a diagram illustrating the boundary line. Furthermore, FIG. 13 is a diagram illustrating a prediction value. As depicted in FIG. 12, the task occurrence prediction unit 113 determines the first line having a gradient “−50” and corresponding to a medium free space (axis of ordinate) “47.50” when the time (axis of abscissas) indicates the execution of the determination process, based on the calculated first value and second value.

Then, when the medium free space present at the operator's operation start time (hereinafter also referred to as a third free space) is smaller than a value on the first line corresponding to a predetermined timing, the task occurrence prediction unit 113 predicts the determination of a determination process that is executed after the predetermined timing is abnormal. Specifically, as depicted in FIG. 13, the task occurrence prediction unit 113, for example, acquires the value of “freeSpace”, which is status information on the monitoring target server group 3, at the operator's operation start time (in the example in FIG. 13, 30 minutes before a scheduled determination process execution time). The example in FIG. 13 assumes that the task occurrence prediction unit 113 determines the value of “freeSpace” to be “50”. Then, the task occurrence prediction unit 113 acquires a value on the first line corresponding to a time 30 minutes before the scheduled determination process execution time. On the first line in FIG. 13, the medium free space present at the time of execution of the determination process is “47.5”, and the value of a change in free space per hour is “−50”. Thus, the medium free space on the first line corresponding to the time 30 minutes before the scheduled determination process execution time is “72.5”. Therefore, in the example in FIG. 13, the acquired value of the status information obtained at the operation start time, “50”, is smaller than the medium free space on the first line, “72.5”. Then, when the free space keeps changing below the first line as in the prediction of changes in medium free space depicted in FIG. 13, the task occurrence prediction unit 113 predicts the branching result of the determination process is to be “abnormal”. The task occurrence prediction unit 113 predicts whether the task is to occur based on the prediction of the branching result of the determination process. In the example in FIG. 6, the medium change (S123), which is a task, is present on a route connecting to the exit with the attribute “abnormal” for the check for a medium free space (S121), which is the determination process. Consequently, in the example in FIG. 6, the task occurrence prediction unit 113 predicts that the medium change (S123), which is a task is to occur.

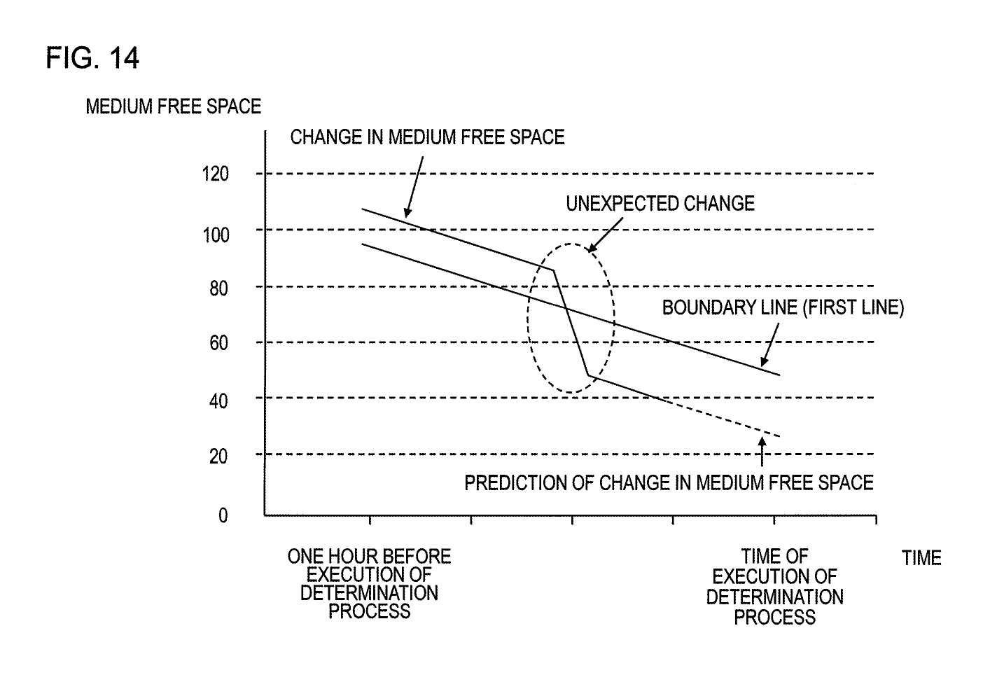

The task occurrence prediction unit 113 performs prediction on the assumption that the medium free space changes along the first line in FIG. 13. However, as depicted in FIG. 14, an unexpected change may occur during the actual change of the medium free space. The unexpected change is a case where, for example, in the backup process, the operator performs manual backup. That is, at the time of task prediction (at the operator's operation start time), even when the medium free space is more than the point on the first line, the medium free space may become less than the point on the first line as a result of a subsequent unexpected change. Thus, the task occurrence prediction unit 113 preferably predicts whether the task is to occur every predetermined time (for example, at periodic timings of every 10 minutes).

[S27 to S29 in FIG. 10]

The process will further be described with reference back to FIG. 10. When the normal route passing the branch of the determination process predicted in S26 is different from the normal route selected in the normal-route selection process (S23) (YES in S27), the task occurrence prediction unit 113 selects the normal route selected in S26 (S28). Thus, the task occurrence prediction unit 113 can perform accurate predictions on tasks that are likely to occur. Then, the task occurrence prediction unit 113 ends predicting whether the task is to occur upon performing the verification in S25 to S28 on all the tasks present in the selected normal route (YES in S29).

[Normal-Route Selection Process (S23)]

Now, the details of the normal-route selection process will be described. As described with reference to FIG. 10, the normal-route selection unit 115 selects a single normal route as an execution route highly expected to be actually executed (the execution route meeting a condition). The task occurrence prediction unit 113 then predicts whether tasks that may occur on the normal route are to occur. The predetermined condition for selection of a single normal route will be described below.

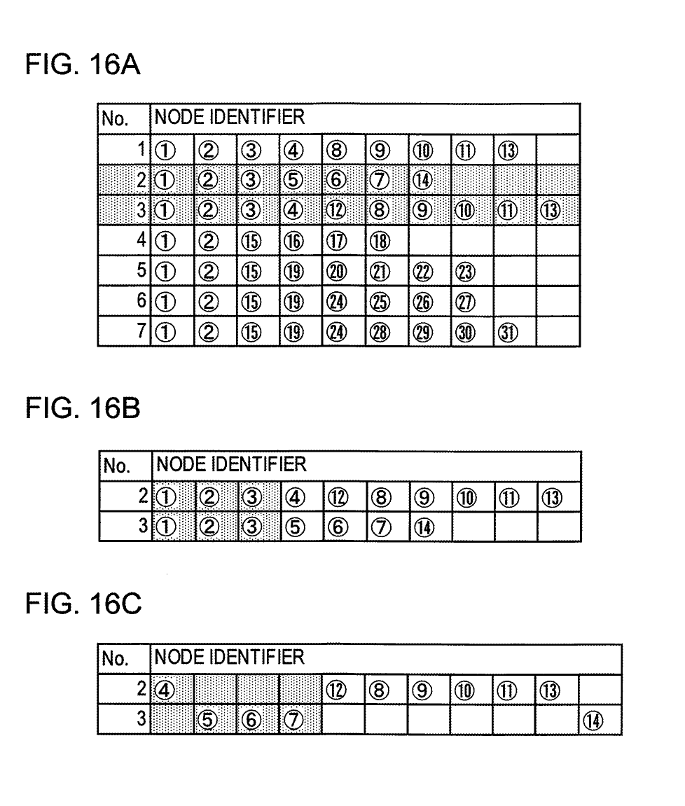

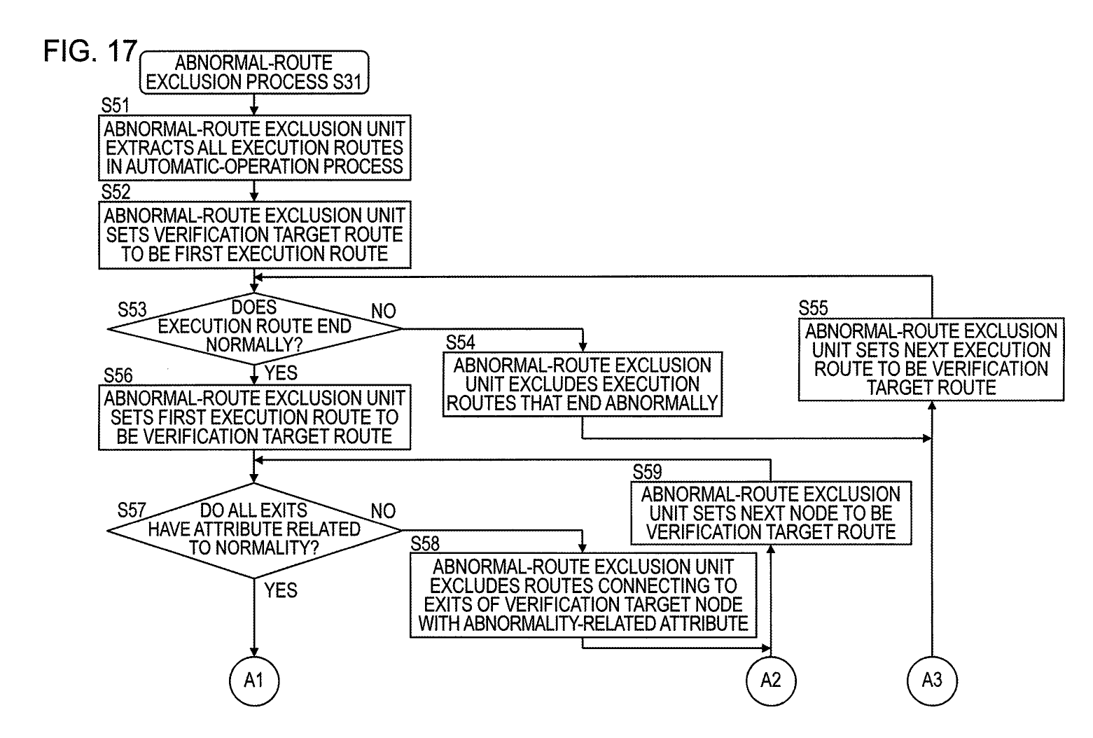

FIG. 15 is a flowchart illustrating the normal-route selection process. FIG. 16A, FIG. 16B and FIG. 16C are diagrams illustrating selection of a normal route. The normal-route selection process in FIG. 15 will be described with reference to FIG. 16A, FIG. 16B and FIG. 16C. First, the normal-route selection unit 115 in the information processing apparatus 1 executes an abnormal-route exclusion process (S31). Abnormal routes are, for example, those of the execution routes in the automatic execution process which end abnormally. Thus, the task occurrence prediction unit 113 can increase the accuracy of predictions performed on tasks that are likely to actually occur. The details of the abnormal-route exclusion process S31 will be described with reference to FIG. 17.

The process will further be described with reference back to FIG. 15. The normal-route selection unit 115 extracts (S32) all the execution routes that have not been excluded by the abnormal-route exclusion process (S31), and further selects two execution routes (hereinafter also referred to as a first route and a second route) from the execution routes that have not been excluded (S33). Then, the normal-route selection unit 115 determines one of the two selected execution routes that is to be left as a candidate for a normal route. The selection of a normal route will be described below.

The example in FIG. 16A, FIG. 16B, and FIG. 16C assumes that seven execution routes (Nos. 1 to 7) are present as candidates for a normal route as depicted in FIG. 16A. In the example in FIG. 16A, FIG. 16B, and FIG. 16C, a case will be described where the execution route No. 3 and the execution route No. 2 are compared with each other as depicted in FIG. 16B. The example in FIG. 16A, FIG. 16B, and FIG. 16C assumes that node identifiers that distinguishes nodes from one another are provided based on the order of development of the nodes from the latest development to the oldest development.

First, the normal-route selection unit 115 excludes nodes present on both of the two execution routes to be compared with each other (execution route No. 3 and execution route No. 2) (S34). This is because the nodes present on both of the two execution routes do not affect the result of comparison. In FIG. 16B, nodes with node identifiers 1 to 3 are present on both of the two execution routes and are thus excluded.

Then, the normal-route selection unit 115 rearranges the nodes included in the two routes in the order of development from the latest development to the oldest development (S35).

In FIG. 16B, on the execution route No. 3, node with node identifiers 4, 12, 8, 9, 10, 11, and 13 are left rather than being excluded. Furthermore, on the execution route No. 2, node with node identifiers 5, 6, 7, and 14 are left rather than being excluded. Then, the normal-route selection unit 115 rearranges the nodes in order of development from the latest development to the oldest development (a string of nodes resulting from the rearrangement is hereinafter also referred to as a node string), as depicted in FIG. 16C. At this time, the normal-route selection unit 115 retains information indicating to which execution route each node belongs.

Then, the normal-route selection unit 115, for example, determines whether or not the latest node and the other nodes of the leading four nodes of the node strings belong to a first route (S36). In the description below, the execution route No. 2 is defined as a first route, and the execution route No. 3 is defined as a second route.

In the example in FIG. 16C, of the leading four nodes of the node string, the node with the node identifier 4, that is, the latest node, belongs to the route No. 2. However, the other nodes (the second, third, and fourth nodes from the leading node of the node string) belong to the execution route No. 3. That is, not all of the leading four nodes of the node string, that is, the node with the node identifier 4, that is, the latest node, and the other nodes, belong to the route No. 2 (NO in S36). Thus, in the example in FIG. 16A, FIG. 16B, and FIG. 16C, the normal-route selection unit 115 excludes the execution route No. 2 (first route) from the candidates for a normal route (S38).

On the other hand, when, in the example in FIG. 16C, of the leading four nodes of the node string, the node with the node identifier 4, that is, the latest node, and the other nodes belong to the execution route No. 2 (YES in S36), the normal-route selection unit 115 excludes the execution route No. 3 (second route) from the candidates for a normal route (S37).

Upon performing the comparison in S34 to S38 on all the execution routes (for the example in FIG. 16A, upon finishing the comparison for all the execution routes No. 1 to No. 7), the normal-route selection unit 115 determines left candidates for a normal route to be normal routes (S40).

On the other hand, when the comparison has not been finished for all the execution routes (NO in S40), the normal-route selection unit 115 selects the execution routes that have not been excluded in S37 or S38 and execution routes that have not been compared with each other yet (S41), and performs the comparison from S34 to S38 on these execution routes.

[Abnormal-Route Exclusion Process (S31)]

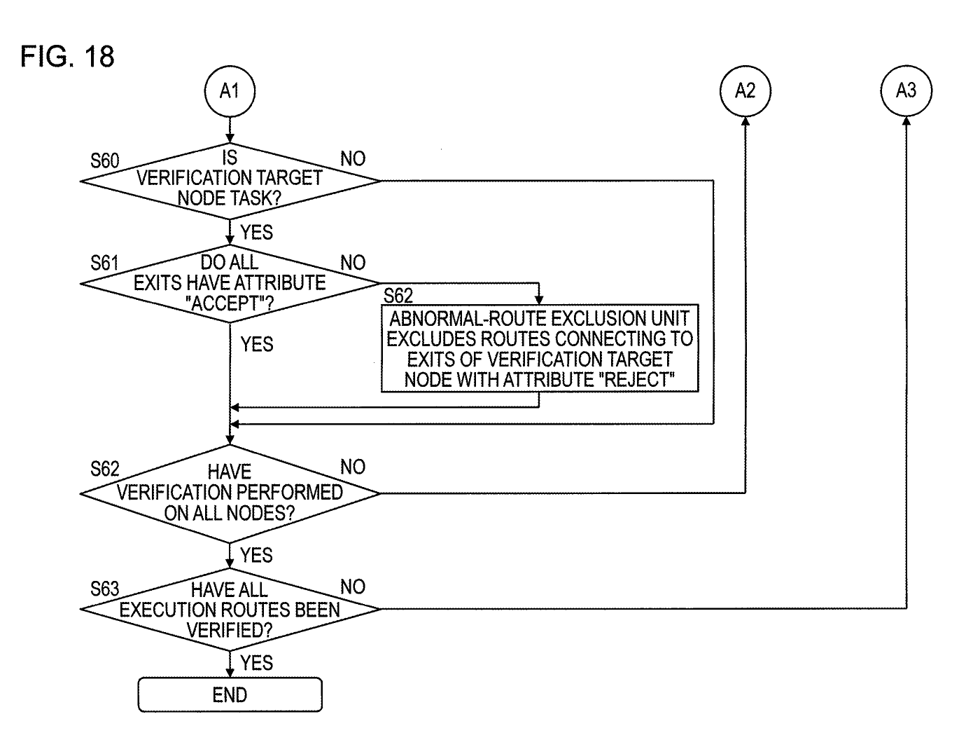

Now, the details of the abnormal-route exclusion process (S31) will be described. FIG. 17 and FIG. 18 are flowcharts illustrating the abnormal-route exclusion process. As depicted in FIG. 16A, FIG. 16B and FIG. 16C, the abnormal-route exclusion process S31 is a process of excluding execution routes that end abnormally from the execution routes as candidates for a normal route before the normal-route selection unit 115 selects normal routes.

Abnormal routes include, for example, execution routes that have ended abnormally, execution routes connecting to abnormality-related exits described with reference to FIG. 4, and execution routes connecting to exits of tasks with the attribute “reject”. The execution route connecting to the abnormality-related exit corresponds to, for example, a route connecting to the exit of the service initiation check (S102) with the attribute “fail” in FIG. 4. Furthermore, the execution route connecting to the exit of the task with the attribute “reject” corresponds to, for example, a route connecting to the exit of the parameter check (S105) with the attribute “reject” in FIG. 4.

In the abnormal-route exclusion process (S31), first, the abnormal-route exclusion unit 114 extracts all the execution routes in the automatic operation process (S51) and sets the first execution route to be a verification target execution route (S52). When the verification target route is an execution route that ends abnormally (NO in S53), the abnormal-route exclusion unit 114 excludes the verification target route that ends abnormally (S54). The abnormal-route exclusion unit 114 sets the next execution route to be the verification target route (S55).

On the other hand, when the verification target route is an execution route that ends normally (YES in S53), the abnormal-route exclusion unit 114 sets the first node to be a verification target node (S56). Then, when an exit with an abnormality-related attribute is present at the verification target node (NO in S57), the abnormal-route exclusion unit 114 excludes, from the verification target route, a route connecting to the exit with the abnormality-related attribute (S58). The abnormal-route exclusion unit 114 then sets the next node to be the verification target route (S59).

Now, a case where all the exits at the verification target node are related to normality will be described (YES in S57). When the verification target node is a task (YES in S60) and the exit with the attribute “reject” is present at the verification target node (NO in S61), the abnormal-route exclusion unit 114 deletes routes connecting to the exits of the verification target node with the attribute “reject” (S62). When the verification target node is not a task, that is, when the verification target node is an operation manipulation component (NO in S60) and when the verification target node is a task and all the exits have the attribute “accept” (YES in S60 and YES in S61), the abnormal-route exclusion unit 114 excludes no execution route.

Then, when the verification has been finished for all the execution routes and all the nodes in the automatic operation process (YES in S63 and YES in S64), the abnormal-route exclusion unit 114 ends the abnormal-route exclusion process (S31). When the verification has not been finished for all of the nodes in the automatic operation process (NO in S63), the abnormal-route exclusion unit 114 sets the next node to be the verification target node (S59) to continue the verification. Furthermore, when the verification has not been finished for all of the routes in the automatic operation process (NO in S64), the abnormal-route exclusion unit 114 sets the next execution route to be the verification target route (S55) to continue the verification.

[Task Time Prediction Process]

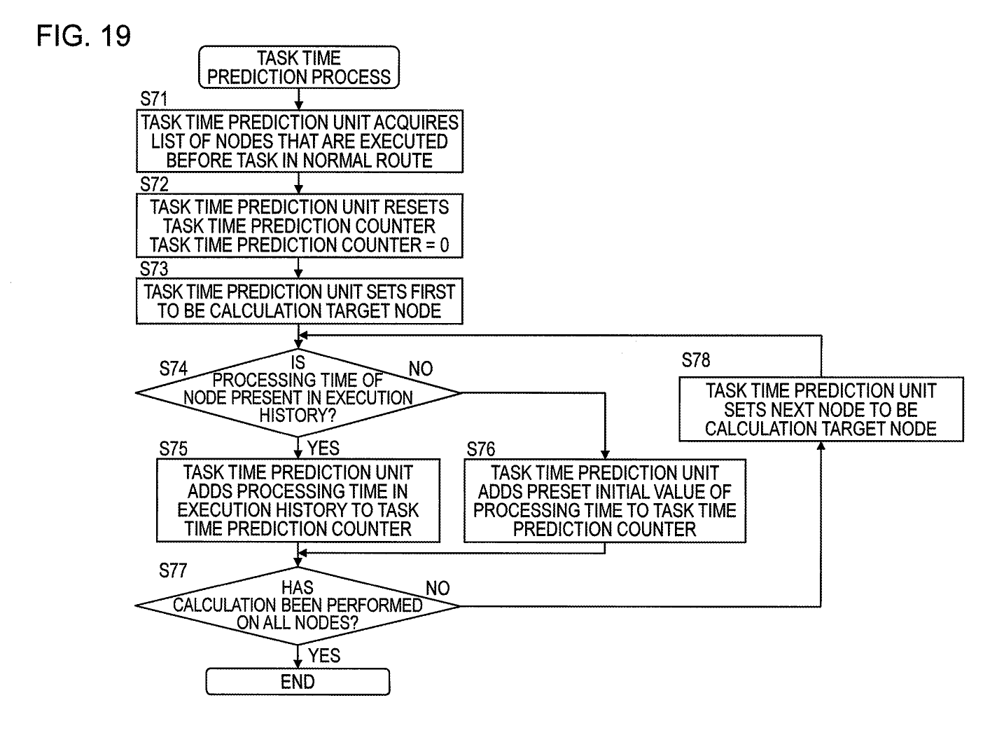

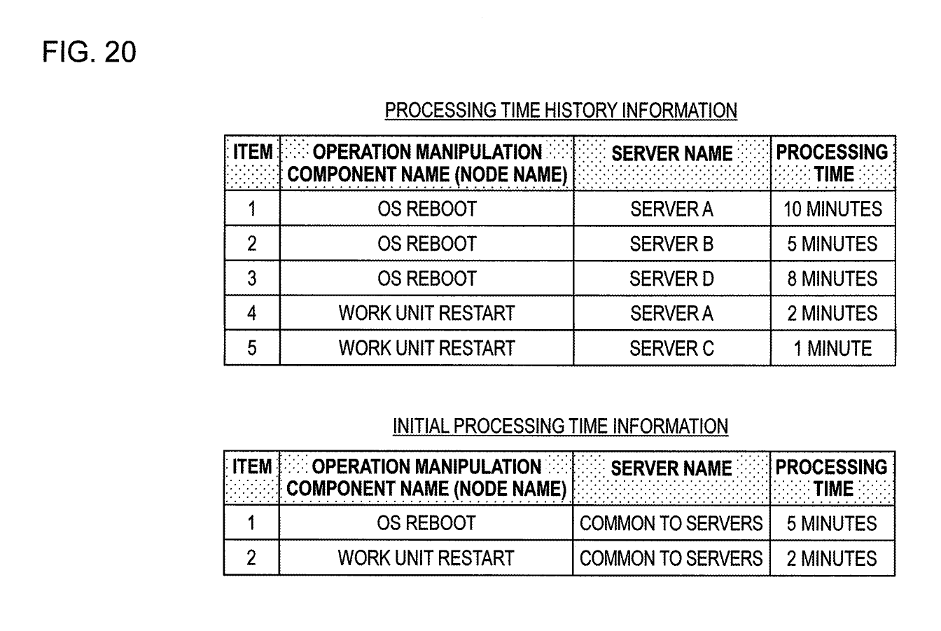

Now, a task time prediction process will be described. The task time prediction process predicts the time when a task in the automatic execution process is to occur. The task time prediction process predicts when the task predicted to occur by the task occurrence prediction unit 113 described with reference to FIG. 5 and FIG. 10 is to occur. FIG. 19 is a flowchart illustrating the task time prediction process. Furthermore, FIG. 20 is a diagram illustrating the execution history of nodes. The task time prediction process in FIG. 19 will be described with reference to FIG. 20.

First, the task time prediction unit 116 acquires a list of nodes (operation management components or tasks) executed before a task in the normal route selected in the task occurrence prediction process (S71). When, for example, a plurality of monitoring target servers 3 is present, the node that is executed before the task is carried out on each of the plurality of servers 3.

Furthermore, the number of servers 3 on which the node needs to be executed may be changed depending on the operation status at the time of execution of the node. Thus, the task time prediction unit 116 preferably acquires the list of the nodes executed before the task each time the task time prediction unit 116 predicts a task occurrence time. The task time prediction unit 116 may acquire the number of servers 3 on which each node is executed using a prepared conditional expression.

Then, the task time prediction unit 116 resets a task time prediction counter (S72), and sets the first node of the nodes acquired in S61 to be a calculation target node (S73).

Then, when the processing time of the calculation target node is present in the execution history (YES in S74), the task time prediction unit 116 adds the processing time in the execution history to the task time prediction counter (S75). On the other hand, when the processing time of the calculation target node is not present in the execution history (NO in S74), the task time prediction unit 116 adds a preset initial value for the processing time to the task time prediction counter (S76).

FIG. 20 is a diagram illustrating the execution history of nodes. The task time prediction unit 116 predicts the processing time based on initial processing time information 123 and processing time history information 124 as depicted in FIG. 20.

A case will be described where, in the example in FIG. 20, servers A to D are present as the monitoring target servers 3. To reference the processing time in the servers A, B, and D in connection with the operation manipulation component “OS reboot”, the task time prediction unit 116 references the processing time history information 124. On the other hand, to reference the processing time in the server C in connection with the operation manipulation component “OS reboot”, the task time prediction unit 116 references the initial processing time information 123 because the processing time history information 124 includes no information on the server C. Similarly, to reference the processing time in the servers A and C in connection with the operation manipulation component “work unit restart”, the task time prediction unit 116 references the processing time history information 124. On the other hand, to reference the processing time in the servers B and D in connection with the operation manipulation component “work unit restart”, the task time prediction unit 116 references the initial processing time information 123.

Specifically, in the example in FIG. 20, when the “OS reboot” is performed from the server A to the server D, the task time prediction unit 116 acquires the processing time in the server A, “10 minutes”, the processing time in the server B, “5 minutes”, and the processing time in the server D, “8 minutes” from the processing time history information 124. Furthermore, the task time prediction unit 116 acquires the processing time common to the servers, “5 minutes”, from the initial processing time information 123, and sets the “5 minutes” to be the processing time in the server C. The task time prediction unit 116 then determines the duration of the operation manipulation component “OS reboot” to be “28 minutes”, the sum of the processing times for the servers. Thus, the task time prediction unit 116 can predict whether the task is to occur with reference to the processing time acquired based on the actual operation status. Consequently, the task occurrence time can be more accurately predicted.

The process will further be described with reference back to FIG. 19. When the calculation of the processing time has not been finished for all the nodes (NO in S77), the task time prediction unit 116 sets the next node to be the calculation target node (S78). The task time prediction unit 116 calculates the processing time of the next node (S74 to S76). On the other hand, when the calculation of the processing time has been finished for all the nodes (YES in S77), the task time prediction unit 116 ends the task time prediction process. Then, the task time prediction unit 116 determines the predicted time from the operation start in the automatic execution process to the start of processing of the prediction target task to be the value in the task time prediction counter obtained at the time of the end of the task time prediction process.

That is, the task time prediction unit 116 calculates the processing time of the node that is executed before the task in the normal route, based on the initial processing time information 123 or the processing time history information 124. Thus, the task time prediction unit 116 can acquire the predicted time from the operation start in the automatic execution process to the start of processing of the prediction target task. Consequently, the operator can acquire not only the prediction of whether the task is to occur but also the prediction of the task occurrence time before the task occurs.

When each operation manipulation component involves processing in a plurality of servers, the servers may execute the processing in series as in the example in FIG. 20 or all the servers (or some of the servers) may execute the processing in parallel. When all the servers execute the processing in parallel, the processing time of the operation manipulation component is the processing time in one of all the servers that has the longest processing time. Specifically, in the example in which the operation manipulation component “OS reboot” is executed in the servers A to D as illustrated in FIG. 20, of the processing times for the server A to the server D, the processing time in the server A, “10 minutes”, is the longest. Thus, when the operation manipulation component “OS reboot” is processed in parallel, the task time prediction unit 116 determines the predicted time of the “OS reboot” to be “10 minutes”.

[Task Time Limit Adjustment Process]

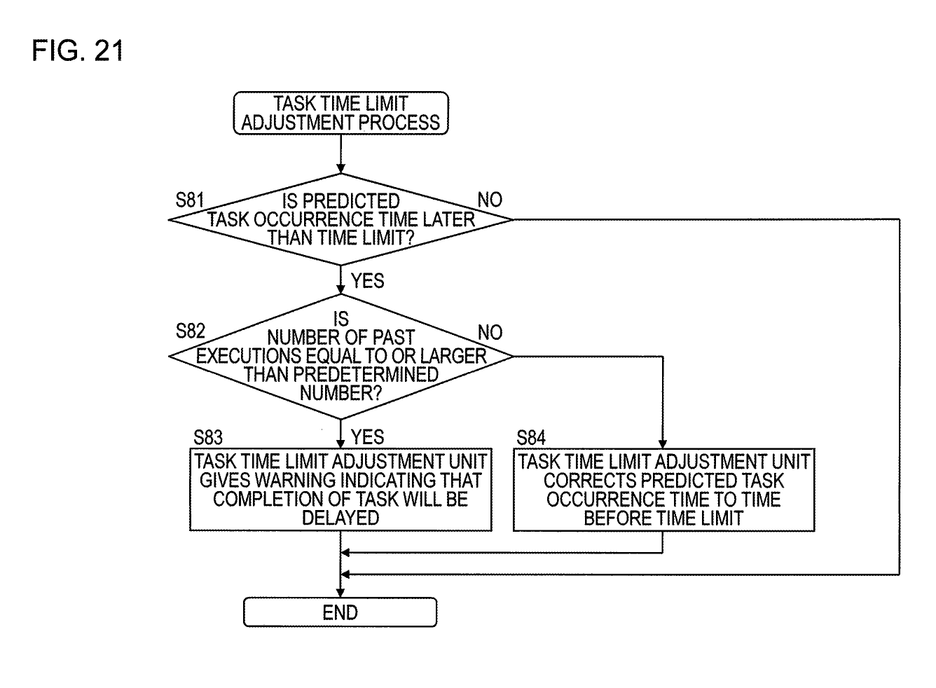

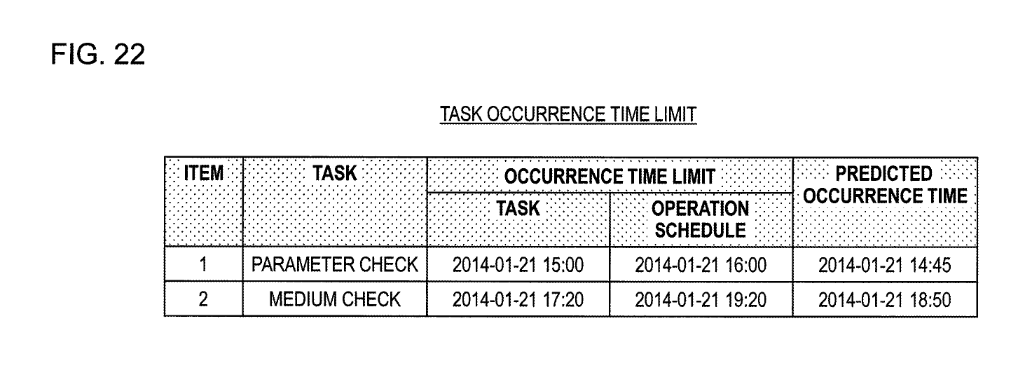

Now, a task time limit adjustment process will be described. FIG. 21 is a flowchart illustrating the task time limit adjustment process. Furthermore, FIG. 22 is a diagram illustrating a time limit on occurrence of a task. The task time limit adjustment process in FIG. 21 will be described with reference to FIG. 22.

The task time limit adjustment process involves adjusting (correcting) the task occurrence time predicted by the task time limit adjustment process. Specifically, when the task occurrence time predicted in the task time prediction process described in FIG. 19 is later than the set processing time limit on the task, the task time limit adjustment process adjusts the predicted task occurrence time.

First, when the task occurrence time predicted by the task time prediction unit 116 is later than the processing time limit (or the time limit on occurrence of the task) on the task (S81), task time limit adjustment unit 118 checks for the number of executions of the prediction target task based on the number-of-task-executions information 125 (S82).

Then, when the number of executions of the prediction target task is equal to or larger than a predetermined number (for example, at least 10) (YES in S72), the task time limit adjustment unit 118 warns the operator that completion of task processing will be delayed (S73). Furthermore, when the number of executions of the prediction target task is equal to or smaller than the predetermined number (NO in S72), the task time limit adjustment unit 118 corrects the predicted task occurrence time to a time before the time limit (S74).

That is, when the number of executions of the prediction target task is equal to or larger than the predetermined number, the task time prediction unit 116 has predicted the task occurrence time based on the past history and is thus reliable. Thus, the task time limit adjustment unit 118 deals with this situation by warning the operator that completion of processing of the task will be delayed.

On the other hand, when the number of executions of the prediction target task is equal to or smaller than the predetermined number, the task time prediction unit 116 may have been predicted the task occurrence time based on the initial processing time information 123. Thus, the prediction is expected not to be reliable. Consequently, the task time limit adjustment unit 118 corrects the predicted task occurrence time.

In the example in FIG. 22, for the task “parameter check”, the time limit on occurrence of the task is “2014-01-21, 15:00”, whereas the predicted task occurrence time is “2014-01-21, 14:55”. That is, the predicted task occurrence time is earlier than the time limit on occurrence of the task. Thus, the task time limit adjustment unit 118 need not deal with the predicted task occurrence time by, for example, making correction.

On the other hand, for the task “medium check”, the time limit on occurrence of the task is “2014-01-21, 17:20”, whereas the predicted task occurrence time is “2014-01-21, 18:50”. That is, the predicted task occurrence time is later than the time limit on occurrence of the task. Thus, when the task “medium check” has been performed at least a predetermined number of times, the task time limit adjustment unit 118 warns the operator that completion of processing of the task will be delayed. Furthermore, when the number of executions of the task “medium check” is equal to or smaller than the predetermined number, the task time limit adjustment unit 118 corrects the predicted task occurrence time.

### Second Embodiment

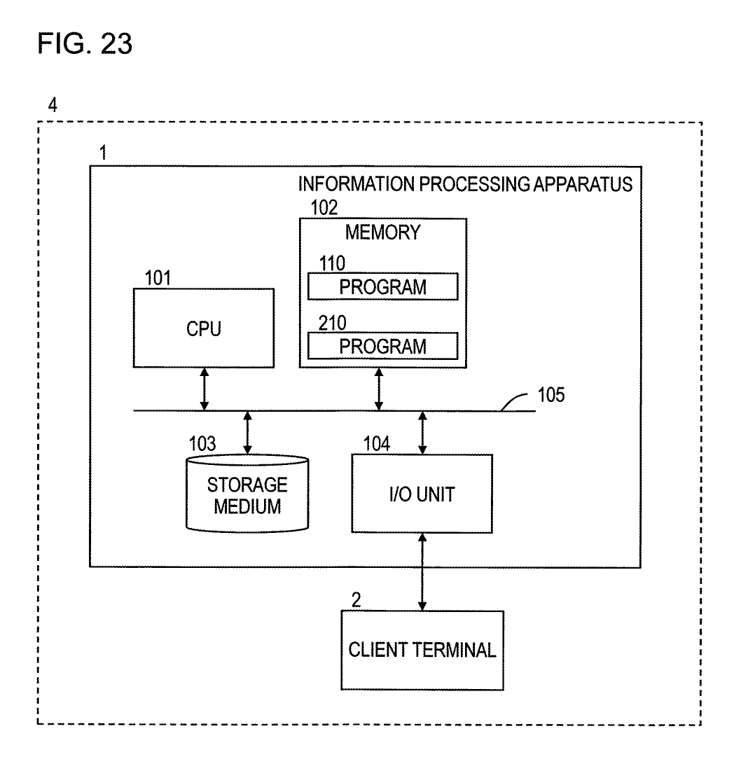

Now, a second embodiment will be described. FIG. 23 is a diagram depicting a hardware configuration of an information processing apparatus according to the second embodiment. In the first embodiment, the case has been described where the information processing apparatus 1 monitors the operation status of the monitoring target server group 3 by performing the operation processes. In contrast, in the second embodiment, a case will be described where the information processing apparatus 1 monitors the operating status of a service operating in the information processing apparatus 1.

As depicted in FIG. 23, the information processing apparatus 1 has a CPU 101 that is a processor, a memory 102, a storage medium 103, and an external interface (I/O unit) 104 as is the case with the description of the first embodiment. These components are connected together via a bus 105.

The storage medium 103 stores, for example, a program 110 that predicts whether a task is to occur, and a program 210 that provides a service to clients (for example, an operation program). Furthermore, in the example in FIG. 23, when the program 210 is to be executed, the CPU 101 loads the program 210 into the memory 102 and cooperates with the program 210 in, for example, executing a process for providing a service to users. Furthermore, when the program 110 is to be executed, the CPU 101 loads the program 110 into the memory 102 and cooperates with the program 110 in, for example, monitoring the status of the service provided by the program 210 to predict whether a task is to occur.

The second embodiment allows the information processing apparatus 1 to internally monitor the information processing apparatus 1 providing the service. Thus, the service can be monitored without provision of a separate monitoring server.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a prediction program that causes a computer to execute a process comprising:
storing accumulated information in a storage unit, in association with a task having previously occurred, the task being a process that needs work performed by an operator, from among a plurality of operation processes executed by an information processing apparatus, the accumulated information including a status information on the information processing apparatus obtained at a time of execution of a determination process from which subsequent processes branch depending on a determination result and which is executed before a task to be predicted, and a branching result of the determination process; and
predicting whether the task is to occur after a predetermined timing based on the status information on the information processing apparatus obtained at the predetermined timing and the accumulated information.

2. The non-transitory computer-readable storage medium storing a prediction program according to claim 1, wherein the predetermined timing is an operation start time of an operator who has a possibility of performing a task within an operation time.

3. The non-transitory computer-readable storage medium storing a prediction program according to claim 1, wherein the prediction process is executed every predetermined time.

4. The non-transitory computer-readable storage medium storing a prediction program according to claim 1, wherein the status information on the information processing apparatus obtained at the time of execution of the determination process has a first free space in the storage medium of the information processing apparatus.

5. The non-transitory computer-readable storage medium storing a prediction program according to claim 4, wherein the storage process further stores, in the storage unit, the accumulated information resulting from association, with the task, a second free space in the storage medium present a predetermined time before the time of execution of the determination process,
the prediction process determines a first value including a mean value of first free spaces stored in the accumulated information determined to be abnormal, and a second value including a mean value of values for a change in free space per unit time based on a difference between the first free space and the second free space corresponding to the first free space,
the prediction process determines, in a graph in which an axis of abscissas represents time and an axis of ordinate represents the free space in the storage medium, a first line passing the first value at the time of execution of the determination process and having a gradient of the second value, and
the prediction process predicts that a determination of the determination process executed after the predetermined timing is abnormal when a value of a third free space in the storage medium present at the predetermined timing is less than a value on the first line corresponding to the predetermined timing, and predicts whether the task is to occur based on the prediction.

6. The non-transitory computer-readable storage medium storing a prediction program according to claim 1, wherein the storage process performs storage of the accumulated information for a determination process that is executed immediately before the task.

7. The non-transitory computer-readable storage medium storing a prediction program according to claim 1, further comprising:
excluding, from among execution routes corresponding to an order of execution of the operation processes possibly executed by the information processing apparatus, an execution route which is passed when the branching result of the determination process is abnormal;
wherein the prediction process performs prediction of whether the task is to occur, on the execution route that has not been excluded.

8. The non-transitory computer-readable storage medium storing a prediction program according to claim 7, further comprising a selection process of selecting, when a plurality of the execution routes has not been excluded by the exclusion process, a single execution route of the plurality of execution routes which meets a predetermined condition,
wherein the prediction process performs prediction of whether the task is to occur, on the execution route selected by the selection process.

9. The non-transitory computer-readable storage medium storing a prediction program according to claim 8, wherein the selection process determines an order of development of the plurality of execution routes that has not been excluded by the exclusion process based on an order of development of the plurality of operation processes, and selects an execution route with an oldest development as an execution route meeting the predetermined condition.

10. The non-transitory computer-readable storage medium storing a prediction program according to claim 1, further comprising:
predicting a timing when the task is to occur by calculating a sum of processing times of the operation processes executed before the task.

11. The non-transitory computer-readable storage medium storing a prediction program according to claim 10, further comprising:
storing the processing time of the executed operation process;
wherein the prediction process calculates the sum of the processing times based on the processing times of the operation processes.

12. A prediction apparatus comprising:
a storage configured to store accumulated information in a storage unit, in association with a task having previously occurred, the task being a process that needs work performed by an operator, from among a plurality of operation processes executed by an information processing apparatus, the accumulated information including a status information on the information processing apparatus obtained at a time of execution of a determination process from which subsequent processes branch depending on a determination result and which is executed before a task to be predicted, and a branching result of the determination process; and
a prediction unit configured to predict whether the task is to occur after a predetermined timing based on the status information on the information processing apparatus obtained at the predetermined timing and the accumulated information.

13. A prediction method comprising:
storing accumulated information in a storage unit, in association with a task having previously occurred, the task being a process that needs work performed by an operator, from among a plurality of operation processes executed by an information processing apparatus, the accumulated information including a status information on the information processing apparatus obtained at a time of execution of a determination process from which subsequent processes branch depending on a determination result and which is executed before a task to be predicted, and a branching result of the determination process; and
predicting whether the task is to occur after a predetermined timing based on the status information on the information processing apparatus obtained at the predetermined timing and the accumulated information.
